(19) United States
(12) Patent Application Publication
(10) Pub. No.: US 2025/0068816 A1
(43) Pub. Date: Feb. 27, 2025

(54) APPARATUS AND METHOD FOR PERFORMANCE-FOCUSED FREQUENCY SELECTION FOR COMPUTE BLOCKS

(71) Applicants: DANA COFFMAN, Portland, OR (US); PREETI AGARWAL, Portland (CA); JOSEPH ALBERTS, Aloha, OR (US); PRAVEEN KUMAR GUPTA, Hillsboro, OR (US)

(72) Inventors: DANA COFFMAN, Portland, OR (US); PREETI AGARWAL, Portland (CA); JOSEPH ALBERTS, Aloha, OR (US); PRAVEEN KUMAR GUPTA, Hillsboro, OR (US)

(21) Appl. No.: 18/375,419

(22) Filed: Sep. 29, 2023

Related U.S. Application Data
(60) Provisional application No. 63/533,837, filed on Aug. 21, 2023.

(51) Int. Cl. G06F 30/373

(52) U.S. Cl. CPC G06F 30/373; G06F 2115/08

(57) ABSTRACT

An apparatus and method are described for performance-optimal frequency selection. For example, one embodiment of a processor comprises: a plurality of different types of intellectual property (IP) circuit blocks including a first type of IP circuit blocks and at least a second type of IP circuit blocks; power management circuitry to perform operations to determine voltages and frequencies at which to operate the plurality of different types of IP circuit blocks, the operations including: determining a plurality of voltage/frequency combinations for the first type of IP circuit block based on stored voltage/frequency curve data; determining maximum frequency values for the second type of IP circuit blocks corresponding to one or more of the plurality of voltage/frequency combinations, the maximum frequency values based on the stored voltage/frequency curve data; adjusting one or more of the maximum frequency values based on one or more corresponding stored scalar values to determine final maximum frequency values for each of the second type of IP circuit blocks; and causing the first type of IP circuit blocks to operate at one of the plurality of voltage/frequency combinations and responsively causing one or more of the second type of IP circuit blocks to operate at a corresponding final maximum frequency value.

### CROSS REFERENCE TO RELATED APPLICATION

This application claims the benefit of U.S. Provisional Patent Application Ser. No. 63/533,837, filed on Aug. 21, 2023, all of which is herein incorporated by reference.

### BACKGROUND

### Field of the Invention

The embodiments of the invention relate generally to the field of computer processors. More particularly, the embodiments relate to an apparatus and method for performance-focused frequency selection for compute blocks.

### Description of the Related Art

In voltage regulator topologies that utilize a common input voltage to supply multiple intellectual property (IP) blocks with differing voltage/frequency operating points, the overall power delivery efficiency is dependent on the full set of frequencies assigned to all IP blocks, and the voltage assigned to the input. This is because the highest requested IP voltage (usually corresponding to the highest requested IP frequency) sets the shared input voltage regulated by the common input. Once this input voltage is established, the efficiency for all of the other IP blocks (those with lower VIN demands) is a fixed function of that chosen input voltage and that domain's output voltage/current.

If frequency selection for each IP block (e.g., each core and interconnect fabric or ring) is allowed to pick arbitrary frequencies without considering these power delivery implications, excess power is lost either in the IP blocks themselves or in their individual voltage regulators sharing the common input voltage. This extra power expended translates into lost performance (lost frequency) when operating in a power-constrained environment.

### BRIEF DESCRIPTION OF THE DRAWINGS

A better understanding of the present invention can be obtained from the following detailed description in conjunction with the following drawings, in which:

FIG. 1 is a block diagram of a processor in accordance with an embodiment of the present disclosure.

FIG. 2 illustrates a system in accordance with an embodiment of the present disclosure.

FIG. 3 illustrates a disaggregated tile-based architecture on which embodiments of the invention may be implemented;

FIG. 4 illustrates additional details of one embodiment of the disaggregated tile-based architecture;

FIG. 5 illustrates different types of power management units;

FIG. 6 illustrates an apparatus in accordance with embodiments of the present disclosure.

FIG. 7 illustrates a method in accordance with embodiments of the present disclosure.

FIG. 8 illustrates an example computing system.

FIG. 9 illustrates a block diagram of an example processor and/or System on a Chip (SoC) that may have one or more cores and an integrated memory controller.

FIG. 10(A) is a block diagram illustrating both an example in-order pipeline and an example register renaming, out-of-order issue/execution pipeline according to examples.

FIG. 10(B) is a block diagram illustrating both an example in-order architecture core and an example register renaming, out-of-order issue/execution architecture core to be included in a processor according to examples.

FIG. 11 illustrates execution units circuitry of one embodiment.

FIG. 12 illustrates a register architecture in accordance with in one embodiment.

FIG. 13 illustrates examples of execution unit(s) circuitry, such as execution unit(s) circuitry.

FIG. 14 is a block diagram of a register architecture according to some examples.

FIG. 15 illustrates examples of a first prefix.

FIGS. 16 (A)-(D) illustrate examples of how the R, X, and B fields of the first prefix are used.

FIGS. 17 (A)-(B) illustrate examples of a second prefix.

FIG. 18 illustrates examples of an instruction format.

FIG. 19 illustrates embodiments for executing binary code of different instruction set architectures.

### DETAILED DESCRIPTION

In various embodiments, techniques are provided for managing power and thermal consumption in a heterogeneous (hetero) processor. As used herein the term “hetero processor” refers to a processor including multiple different types of processing engines. For example, a hetero processor may include two or more types of cores that have different microarchitectures, instruction set architectures (ISAs), voltage/frequency (VF) curves, and/or more broadly power/performance characteristics.

Optimal design/operating point of a heterogeneous processor (in terms of VF characteristics, instructions per cycle (IPC), functionality/ISA, etc.) is dependent on both inherent/static system constraints (e.g., common voltage rail) and a dynamic execution state (e.g., type of workload demand, power/thermal state, etc.). To extract power efficiency and performance from such architectures, embodiments provide techniques to determine/estimate present hardware state/capabilities and to map application software requirements to hardware blocks. With varying power/thermal state of a system, the relative power/performance characteristics of different cores change. Embodiments take these differences into account to make both local and globally optimal decisions. As a result, embodiments provide dynamic feedback of per core power/performance characteristics.

More specifically, embodiments provide closed loop control of resource allocation (e.g., power budget) and operating point selection based on the present state of heterogeneous hardware blocks. In embodiments, a hardware guided scheduling (HGS) interface is provided to communicate dynamic processor capabilities to an operating system (OS) based on power/thermal constraints. Embodiments may dynamically compute hardware (HW) feedback information, including dynamically estimating processor performance and energy efficiency capabilities. As one particular example, a lookup table (LUT) may be accessed based on underlying power and performance (PnP) characteristics of different core types and/or post-silicon tuning based on power/performance bias.

In addition, embodiments may determine an optimal operating point for the heterogeneous processor. Such optimal operating point may be determined based at least in part on a present execution scenario, including varying workload demands (performance, efficiency, responsiveness, throughput, IO response) of different applications, and shifting performance and energy efficiency capabilities of heterogeneous cores.

In embodiments, the dynamically computed processor performance and energy efficiency capabilities may be provided to an OS scheduler. The feedback information takes into account power and thermal constraints to ensure that current hardware state is provided. In this way, an OS scheduler can make scheduling decisions that improve overall system performance and efficiency. Note that this feedback is not dependent on workload energy performance preference (EPP) or other software input. Rather, it is based on physical constraints that reflect current hardware state.

In contrast, conventional power management mechanisms assume all cores to be of the same type, and thus estimate the maximum achievable frequency on each core to be same for a given power budget. This is not accurate, as different cores may have different power/performance capabilities individually and they may have different maximum frequency based on other platform constraints. And further, conventional power management algorithms assume the same utilization target for all cores when calculating performance state (P-state) and hence do not take into account the heterogeneity of an underlying architecture. Nor do existing techniques optimize the operating points with an objective of mapping a particular type of thread to a core type based on optimizing power or performance.

In general, a HGS interface provides dynamic processor capabilities to the OS based on power/thermal constraints. The OS takes this feedback as an input to a scheduling algorithm and maps workload demand to hetero compute units. The scheduler's mapping decisions may be guided by different metrics such as performance, efficiency or responsiveness, etc. The scheduling decisions in turn impact processor states, hence forming a closed loop dependence. Since workload demand, in terms of power/performance requirements, can vary by large margins, any change in scheduling decisions can cause a large shift in HGS feedback, leading to unacceptable stability issues. Embodiments provide techniques that are independent/resilient of the scheduling decisions or other software inputs from the operating system, and thus avoid these stability issues.

Although the following embodiments are described with reference to specific integrated circuits, such as in computing platforms or processors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to any particular type of computer systems. That is, disclosed embodiments can be used in many different system types, ranging from server computers (e.g., tower, rack, blade, micro-server and so forth), communications systems, storage systems, desktop computers of any configuration, laptop, notebook, and tablet computers (including 2:1 tablets, phablets and so forth), and may be also used in other devices, such as handheld devices, systems on chip (SoCs), and embedded applications. Some examples of handheld devices include cellular phones such as smartphones, Internet protocol devices, digital cameras, personal digital assistants (PDAs), and handheld PCs. Embedded applications may typically include a microcontroller, a digital signal processor (DSP), network computers (NetPC), set-top boxes, network hubs, wide area network (WAN) switches, wearable devices, or any other system that can perform the functions and operations taught below. More so, embodiments may be implemented in mobile terminals having standard voice functionality such as mobile phones, smartphones and phablets, and/or in non-mobile terminals without a standard wireless voice function communication capability, such as many wearables, tablets, notebooks, desktops, micro-servers, servers and so forth. Moreover, the apparatuses, methods, and systems described herein are not limited to physical computing devices, but may also relate to software optimizations.

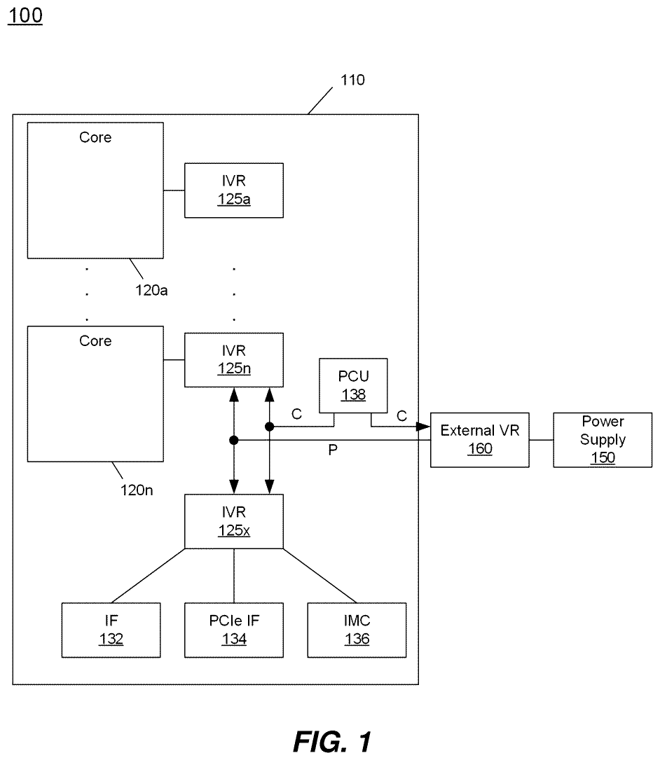

Referring now to FIG. 1, shown is a block diagram of a portion of a system in accordance with an embodiment of the present invention. As shown in FIG. 1, system 100 may include various components, including a processor 110 which as shown is a multicore processor. Processor 110 may be coupled to a power supply 150 via an external voltage regulator 160, which may perform a first voltage conversion to provide a primary regulated voltage to processor 110.

As seen, processor 110 may be a single die processor including multiple cores 120 a-120 n. In addition, each core may be associated with an integrated voltage regulator (IVR) 125 a-125 n which receives the primary regulated voltage and generates an operating voltage to be provided to one or more agents of the processor associated with the IVR. Accordingly, an IVR implementation may be provided to allow for fine-grained control of voltage and thus power and performance of each individual core. As such, each core can operate at an independent voltage and frequency, enabling great flexibility and affording wide opportunities for balancing power consumption with performance. In some embodiments, the use of multiple IVRs enables the grouping of components into separate power planes, such that power is regulated and supplied by the IVR to only those components in the group. During power management, a given power plane of one IVR may be powered down or off when the processor is placed into a certain low power state, while another power plane of another IVR remains active, or fully powered.

Still referring to FIG. 1, additional components may be present within the processor including an input/output interface 132, another interface 134, and an integrated memory controller 136. As seen, each of these components may be powered by another integrated voltage regulator 125 x. In one embodiment, interface 132 may be enable operation for an Intel® Quick Path Interconnect (QPI) interconnect, which provides for point-to-point (PtP) links in a cache coherent protocol that includes multiple layers including a physical layer, a link layer and a protocol layer. In turn, interface 134 may communicate via a Peripheral Component Interconnect Express (PCIe™) protocol.

Also shown is a power control unit (PCU) 138, which may include hardware, software and/or firmware to perform power management operations with regard to processor 110. As seen, PCU 138 provides control information to external voltage regulator 160 via a digital interface to cause the voltage regulator to generate the appropriate regulated voltage. PCU 138 also provides control information to IVRs 125 via another digital interface to control the operating voltage generated (or to cause a corresponding IVR to be disabled in a low power mode). In various embodiments, PCU 138 may include a variety of power management logic units to perform hardware-based power management. Such power management may be wholly processor controlled (e.g., by various processor hardware, and which may be triggered by workload and/or power, thermal or other processor constraints) and/or the power management may be performed responsive to external sources (such as a platform or management power management source or system software).

In embodiments herein, PCU 138 may be configured to dynamically determine hardware feedback information regarding performance and energy efficiency capabilities of hardware circuits such as cores 120 and provide an interface to enable communication of this information to an OS scheduler, for use in making better scheduling decisions. To this end, PCU 138 may be configured to determine and store such information, either internally to PCU 138 or in another storage of system 100.

Furthermore, while FIG. 1 shows an implementation in which PCU 138 is a separate processing engine (which may be implemented as a microcontroller), understand that in some cases in addition to or instead of a dedicated power controller, each core may include or be associated with a power control agent to more autonomously control power consumption independently. In some cases a hierarchical power management architecture may be provided, with PCU 138 in communication with corresponding power management agents associated with each of cores 120.

While not shown for ease of illustration, understand that additional components may be present within processor 110 such as uncore logic, and other components such as internal memories, e.g., one or more levels of a cache memory hierarchy and so forth. Furthermore, while shown in the implementation of FIG. 1 with an integrated voltage regulator, embodiments are not so limited.

Processors described herein may leverage power management techniques that may be independent of and complementary to an operating system (OS)-based power management (OSPM) mechanism. According to one example OSPM technique, a processor can operate at various performance states or levels, so-called P-states, namely from P0 to PN. In general, the P1 performance state may correspond to the highest guaranteed performance state that can be requested by an OS. In addition to this P1 state, the OS can further request a higher performance state, namely a P0 state. This P0 state may thus be an opportunistic or turbo mode state in which, when power and/or thermal budget is available, processor hardware can configure the processor or at least portions thereof to operate at a higher than guaranteed frequency. In many implementations a processor can include multiple so-called bin frequencies above the P1 guaranteed maximum frequency, exceeding to a maximum peak frequency of the particular processor, as fused or otherwise written into the processor during manufacture. In addition, according to one OSPM mechanism, a processor can operate at various power states or levels. With regard to power states, an OSPM mechanism may specify different power consumption states, generally referred to as C-states, C0, C1 to Cn states. When a core is active, it runs at a C0 state, and when the core is idle it may be placed in a core low power state, also called a core non-zero C-state (e.g., C1-C6 states), with each C-state being at a lower power consumption level (such that C6 is a deeper low power state than C1, and so forth).

Understand that many different types of power management techniques may be used individually or in combination in different embodiments. As representative examples, a power controller may control the processor to be power managed by some form of dynamic voltage frequency scaling (DVFS) in which an operating voltage and/or operating frequency of one or more cores or other processor logic may be dynamically controlled to reduce power consumption in certain situations. In an example, DVFS may be performed using Enhanced Intel SpeedStep™ technology available from Intel Corporation, Santa Clara, Calif., to provide optimal performance at a lowest power consumption level. In another example, DVFS may be performed using Intel TurboBoost™ technology to enable one or more cores or other compute engines to operate at a higher than guaranteed operating frequency based on conditions (e.g., workload and availability).

Another power management technique that may be used in certain examples is dynamic swapping of workloads between different compute engines. For example, the processor may include asymmetric cores or other processing engines that operate at different power consumption levels, such that in a power constrained situation, one or more workloads can be dynamically switched to execute on a lower power core or other compute engine. Another exemplary power management technique is hardware duty cycling (HDC), which may cause cores and/or other compute engines to be periodically enabled and disabled according to a duty cycle, such that one or more cores may be made inactive during an inactive period of the duty cycle and made active during an active period of the duty cycle.

The manufacturer determines a base clock frequency value for a processor through design and testing processes, and may label the base clock frequency value on the processor. The base clock frequency value assigned by the manufacturer is typically determined based on a particular usage scenario. An example of the particular usage scenario may be a specific combination of worst case workload, a TDP target, a reliability target etc. The manufacturer commonly does not provide an end user with any mechanism to change the base clock frequency value of the processor (e.g., to a value higher than the assigned base clock frequency value). This prohibition is to prevent violations of the TDP requirement of the processor. Although a processor may include hardware features (e.g., the Turbo Boost Technology) that allow the processor to opportunistically run above the base clock frequency value labeled by the manufacturer, these hardware features do not guarantee the processor to run at a clock speed higher than the base clock frequency value for a determined workload. Because the Turbo Boost Technology does not guarantee a sustained clock speed for the workload, a cloud service provider cannot price the cloud service provided using these opportunistic high clock frequencies when entering a service level agreement (SLA) with a customer.

Embodiments of the present disclosure address the above-noted and other deficiencies by providing, to end users, options to set the base clock frequency of a processor to a value above or below the manufacturer-assigned base clock frequency value for different usage scenarios. A usage scenario may be specified by a set of parameters including, for example, a target number of processing cores in the processor to be used, a target thermal design power (TDP) quantity, a target workload (e.g., as a percentage of the TDP), and a target reliability measurement (e.g., useful life of the processor). Embodiments may include a user interface that may provide a user with the options to choose a target usage scenario from a list of usage scenarios. For example, the user interface may include these options during the booting process. Alternatively, an application running on the processor may provide these options. The processor or a controller circuit associated with the processor may utilize the selected usage scenario to determine a target base clock frequency value for a set of processing cores in the processor. The set of processing cores may be fewer than all of the processing cores in the processor (e.g., 2 out of 6 processing cores). The processor or a controller may also utilize the usage scenarios to determine a set of target base clock frequency values for multiple disjoint sets of processing cores in the processor (e.g. 2 out of 6 processing cores at a first base clock frequency value (X) and remaining 4 out of 6 processing cores at a second base clock frequency value (Y)). Further, the processor may update the base clock frequency value used by a firmware (PCU firmware) running on a power management circuit associated with the processor to the target base clock frequency value. The PCU firmware may calculate power consumptions and heat generation based on the target base clock frequency value for the set of processing cores. Responsive to setting the PCU calculation according to the target base clock frequency value, the processor may configure the set of processing cores to run at the target base clock frequency value and enable the set of processing cores to run at the target base clock frequency value. This way, a cloud service provider may price the enhanced target base clock frequency value with the end user in a service level agreement.

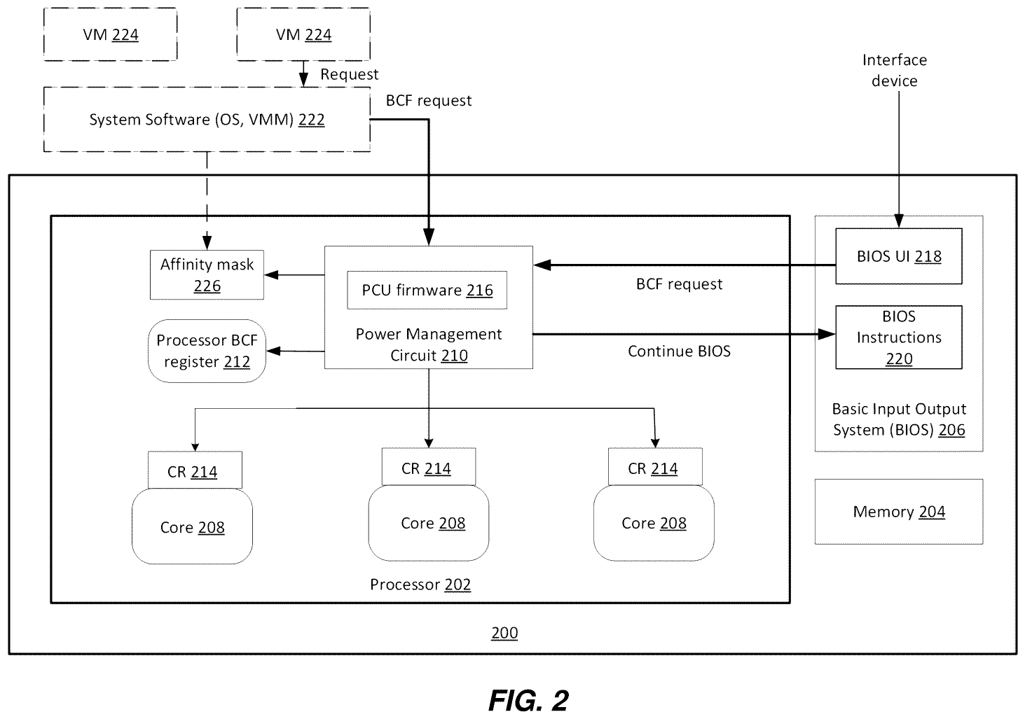

FIG. 2 illustrates a system 200 according to an embodiment of the present disclosure. As shown in FIG. 2, processing system 200 (e.g., a system-on-a-chip (SOC) or a motherboard of a computer system) may include a processor 202 and a memory device 204 communicatively coupled to processor 202. Processor 202 may be a hardware processing device such as, for example, a central processing unit (CPU) or a graphic processing unit (GPU) that includes one or more processing cores 208 to execute software applications. System 200 may also include a Basic Input Output System (BIOS) chipset 206 to store system initiation instructions during system boot (e.g., at power on). BIOS chipset 206 can be a read-only memory (ROM) or a flash memory to store these instructions.

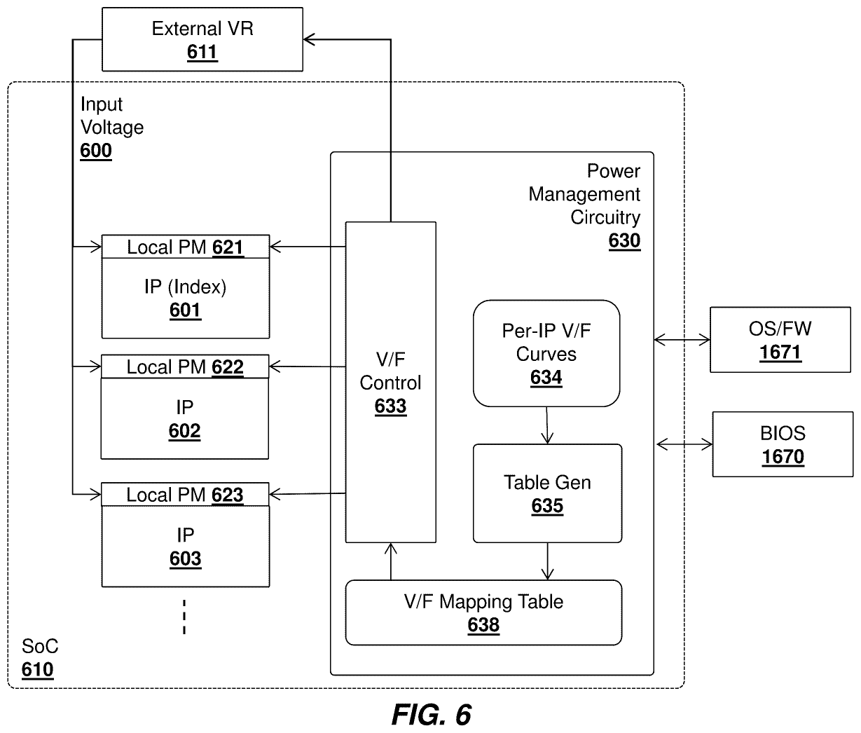

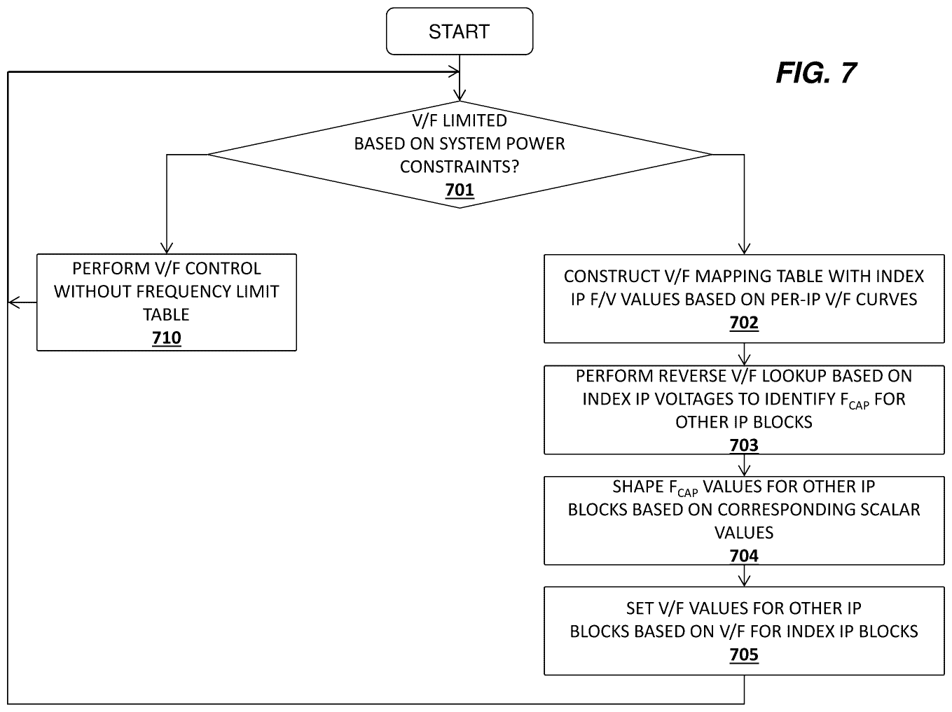

Processor 202 may further include processing cores 208, a power management circuit 210 (such as, for example, the power control unit (PCU) of x86 processors), and control registers 212, 214, 226. Processing cores 208 in various implementations may be provided by in-order cores or out-or-order cores. In an illustrative example, processing core 208 may have a micro-architecture including processor logic and circuits used to implement an instruction set architecture (ISA). Processors 202 with different micro-architectures can share at least a portion of a common instruction set. For example, the same register architecture of the ISA may be implemented in different ways in different micro-architectures using various techniques, including dedicated physical registers, one or more dynamically allocated physical registers using a register renaming mechanism (e.g., the use of a register alias table (RAT), a reorder buffer (ROB) and a retirement register file), as illustrated by FIGS. 6-7.

As discussed above, the manufacturer, during the fabrication and testing of the processor, may determine a base clock frequency value for processor 202. A base clock frequency value is the highest certified clock speed at which processor 202 can run with a pre-determined workload (e.g., a worst workload). A workload of a task running on processor 202 can be measured in terms of the number of clock cycles used to perform the task. The upper limit of instructions that can be executed per clock cycle is determined based on many factors including the heat generated by the execution of these instructions. In one embodiment, processor 202 may include control register 212 (referred to as processor base clock frequency (BCF) register) to store the base clock frequency value assigned to processor 202. The pre-determined base clock frequency value is the default, initial value stored in control register 212. In one embodiment, each one of processing cores 208 may be associated with a respective control register 214 to store a corresponding base clock frequency value for the corresponding core 208. Each control register 214 obtained from the manufacturer may store the default base clock frequency value assigned to processor 202. Additionally, control register 226 may store an affinity mask to indicate which processing cores 208 are active. In one embodiment, affinity mask 226 is a bit map, where each bit stores an activity status for a corresponding processing core. For example, when a bit is set to an active status (e.g., “1”), the corresponding processing core is to run according the base clock frequency value associated with the processing core. When the bit is set to an inactive status (e.g., “0”), the corresponding processing core is not available to software applications or is idle. In one embodiment, power management circuit 210 may determine which processor cores 208 are active, and to set bits in the affinity mask corresponding to active processing cores to the active status and bits corresponding to inactive processing cores to the inactive status. In another embodiment, system software 222 may set the affinity mask.

In another embodiment, processor BCF register 212 may store a data structure including data items, wherein each data item may contain a processing core identifier and a corresponding per-core base clock frequency value as well as the affinity mask bit. In another embodiment, BCF register 212 may store a reference to a data structure stored in a memory, where the data structure includes the data items. Thus, processing cores 208 may operate according to the per-core base clock frequency values stored in the data structure. The per-core base clock frequency values allow each processing core to operate at its own base clock frequency which may be different from another processing core or from the base clock frequency value of the processor 202.

Power management circuit 210 can be a microcontroller programmed with a power control unit (PCU) firmware 216. PCU firmware 216 may include code encoding functionalities associated with managing processor temperature based on the base clock frequency value of processor 202 and/or the per-core base clock frequency values of processing cores 208. In one embodiment, power management circuit 210 executing PCU firmware 216 may, during the boot, read BIOS instructions 220 stored in BIOS chipset 206 to perform the initialization of system 200. PCU firmware 216 may also include code to manage, based on thermal sensor data and workload requests generated by system software 222, base clock frequency values associated processor 202 and/or processing cores 208. For example, PCU firmware 216 may shut down inactive processing cores and divert the spare power to active processing cores. PCU firmware 216 may also calculate, based on a thermal generation model of the processing device, a thermal energy generated by the processing device. The thermal generation model may use the base clock frequency values of active processing cores as input parameters.

The manufacturer may determine the base clock frequency value of processor 202 based on a pre-determined set of usage scenarios for the processor utilizing all of the processing cores 208. In operation, the target usage scenarios may differ from the pre-determined set of usage conditions that had been tested by the manufacturer. In some situations, the target usage scenario may allow processor 202 or some processing cores 208 of processor 202 to run at a target base clock frequency value that is higher than the base clock frequency value assigned by the manufacturer. In one embodiment of the present disclosure, processor 202 may provide firmware (e.g., PCU firmware 216 during BIOS booting up) with a hardware interface to allow changing the base clock frequency value stored in control register 212 of processor 202 and/or values stored in control registers 214 of processing cores 208 (including the affinity mask stored in control register 226). Further, processor 202 may also expose an application programming interface (API) to system software 222 (e.g., the operating system or the virtual machine monitor (VMM)) to allow the system software to identify the usage scenario and send a base clock frequency request, using the API, to power management circuit 210. The request may include the target base clock frequency value determined by system software 222 for a usage scenario. Power management circuit 210 may set the target base clock frequency for one or more processing cores based on the request.

In one embodiment, BIOS chipset 206 may generate the base clock frequency request during the boot process of processing system 200. In another embodiment, system software (e.g., the operating system or VMM) 222 may generate the base clock frequency request in response to a change of usage scenario (e.g., addition/removal of a virtual machine). The base clock frequency request received by power management circuit 210 may include a number of processing cores determined (a subset of, or all available processing cores) based on a usage scenario and the target base frequency value associated with these processing cores. Responsive to receiving the base clock frequency request, PCU firmware 216 running on power management circuit 210 may set the target base frequency value associated with these processing cores and the corresponding bits in the affinity mask. In one embodiment, the PCU firmware 216 may change the base clock frequency value of processor 202 by storing the target base clock frequency value in control register 212, and change the base clock frequency of processing core 208 by storing the target base clock frequency value in a corresponding control register 214.

In one embodiment, processing system 200 may, during the system boot process, display options to an end user to choose a usage scenario in order to generate, based on end user selection, a base clock frequency request to power management circuit 210. As shown in FIG. 2, BIOS chipset 206 may store instructions that, when executed during the boot process, present a BIOS user interface 218 on an input/output device (e.g., display device and a keyboard or a mouse) and further store BIOS instructions 220 for setting up different devices of processing system 200. BIOS user interface 218 may present, on an interface device (e.g., a display device), the status at different stages of the boot process. In one embodiment, BIOS user interface 218 may present a list of usage scenarios to the user. Responsive to receiving a selection of a usage scenario, the boot process may include the execution of instructions (e.g., by power management circuit 216) to generate a base clock frequency request to power management circuit 210. The base clock frequency request may include the target base clock frequency value and optionally the number of processing cores to run at the target base clock frequency value. Power management circuit 210 may then set up processor 202 based on the received base clock frequency request.

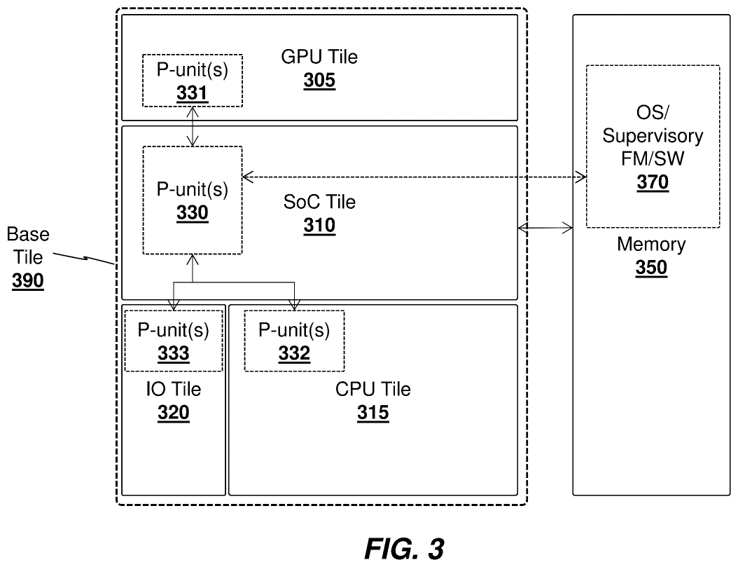

FIG. 3 illustrates an example of a processor with a disaggregated architecture comprising an SoC tile 310, a CPU tile 315, A GPU tile 305, and an IO tile 320 which are integrated on a common base tile 390 coupled to a package substrate. In some embodiments, each tile comprises a separate die or chip which communicates with other dies/chips over horizontal and/or vertical interconnects (e.g., through-silicon vias). The SoC tile 310 includes a memory controller to couple the processor to system memory 350 and provides various other SoC-level functions such as coherent fabric interconnects between the various IP blocks, a display engine, and a low-power IP block which remains operational, even when the processor enters into low power states.

Some embodiments implement a distributed power management architecture comprising a plurality of power management units (P-units) 330-333 distributed across the various dies 305, 310, 315, 320, respectively. In certain implementations, the P-units 330-333 are configured as a hierarchical power management subsystem in which a single P-unit (e.g., the P-unit 330 on the SoC tile 310 in several examples described herein) operates as a supervisor P-unit which collects and evaluates power management metrics provided from the other P-units 331-333 to make package-level power management decisions and determine power/performance states at which each of the tiles and/or individual IP blocks are to operate (e.g., the frequencies and voltages for each of the IP blocks).

The supervisor P-unit 330 communicates the power/performance states to the other P-units 331-333, which implement the power/performance states locally, on each respective tile. In some implementation, the package-wide power management decisions of the supervisor P-unit 330 include decisions described herein involving core parking and/or core consolidation.

An operating system (OS) and/or other supervisory firmware (FW) or software (SW) 370 may communicate with the supervisory P-unit 330 to exchange power management state information and power management requests (e.g., such as the “hints” described herein). In some implementations described herein, the communication between the OS/supervisory FW/SW 370 and the P-unit 330 occurs via a mailbox register or set of mailbox registers. In some embodiments, a Baseboard Management Controller (BMC) or other system controller may exchange power control messages with the supervisory P-unit 330 via these mailbox registers or a different set of mailbox registers.

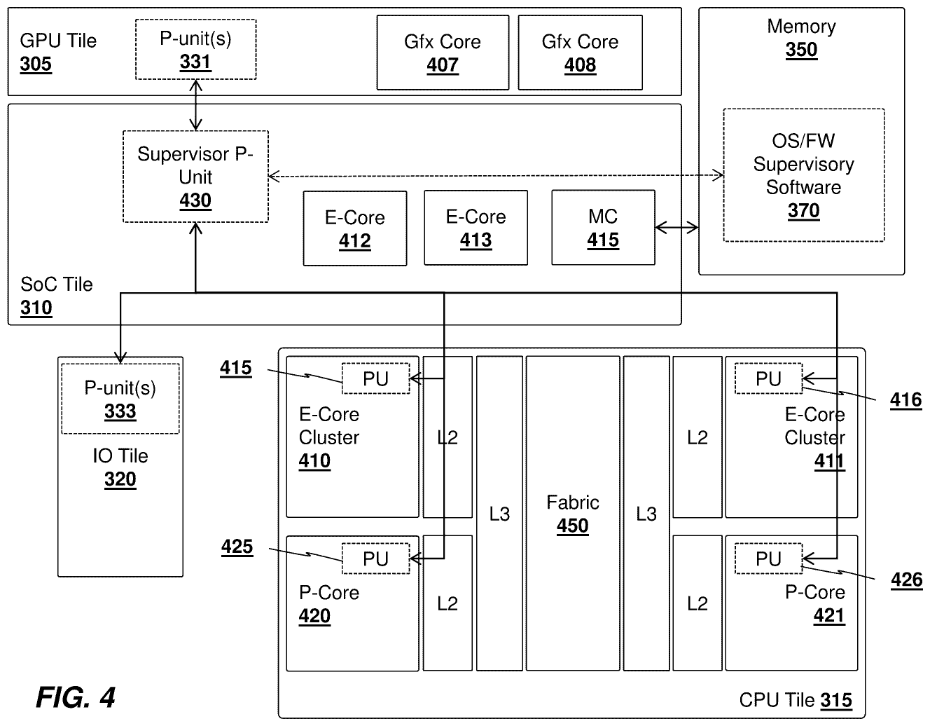

FIG. 4 illustrates additional details of one embodiment of a CPU tile 315, which includes a heterogeneous set of cores including efficiency cores (E-cores) arranged into two E-core clusters 410-411 and a plurality of performance cores (P-cores) 420-421. Some embodiments of the SoC tile 310 include a set of E-cores 412-413 and a memory controller 415 to couple the processor to system memory 350 (e.g., DDR DRAM memory, HBM memory, etc). Similarly, the GPU tile 305 includes a plurality of graphics cores 407-408 which may be managed in the same manner as the P-cores and E-cores as described herein.

The E-cores in the E-core clusters 410-411 and the SoC tile 310 are physically smaller (with multiple E-cores fitting into the physical die space of a P-core), are designed to maximize CPU efficiency, measured as performance-per-watt, and are typically used for scalable, multi-threaded performance. The E-cores work in concert with P-cores 420-421 to accelerate tasks which tend to consume a large number of cores. The E-cores are optimized to run background tasks efficiently and, as such, smaller tasks are typically offloaded to E-cores (e.g., handling Discord or antivirus software)—leaving the P-cores 420-421 free to drive high performance tasks such as gaming or 3D rendering.

The P-cores 420-421 are physically larger, high-performance cores which are tuned for high turbo frequencies and high IPC (instructions per cycle) and are particularly suited to processing heavy single-threaded work. In some embodiments, the P-cores are also capable of hyper-threading (i.e., concurrently running multiple software threads).

In the illustrated embodiment, separate P-units 415-416 are associated with each E-core cluster 410-411, respectively, to manage power consumption within each respective E-core cluster in response to messages from the supervisor P-unit 430 and to communicate power usage metrics to the supervisor P-unit 430. Similarly, separate P-units 425-426 are associated with each P-core 420-421, respectively, to manage power/performance of the respective P-core in response to the supervisor P-unit 430 and to collect and communicate power usage metrics to the supervisor P-unit 430.

In one embodiment, the local P-units 415-416, 425-426 manage power locally by independently adjusting frequency/voltage levels to each E-core cluster 410-411 and P-core 420-421, respectively. For example, P-units 415-416 control digital linear voltage regulators (DLVRs) and/or fully integrated voltage regulators (FIVRs) to independently manage the frequency/voltage applied to each E-core within the E-core clusters 410-411. Similarly, P-units 425-426 control another set of DLVRs and/or FIVRs to independently manage the frequency/voltage applied to each P-core 420-421. The graphics cores 407-408 and/or E-cores 412-413 may be similarly controlled via DLVRs/FIVRs. In these implementations, the frequency/voltage associated with a first core may be dynamically adjusted independently—i.e., without affecting the frequencies/voltages of one or more other cores. The dynamic and independent control of individual E-cores/P-cores provides for processor-wide Dynamic Voltage and Frequency Scaling (DVFS) controlled by the supervisor P-unit 430.

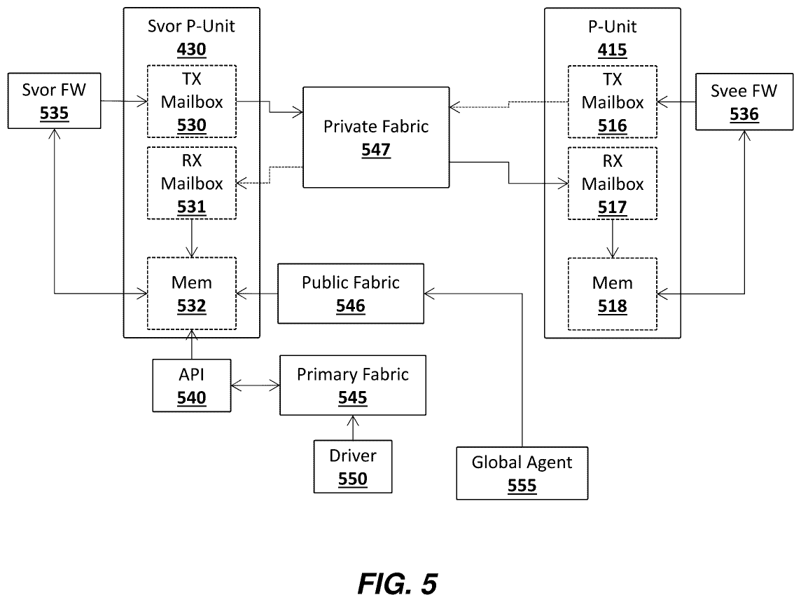

As illustrated in FIG. 5, in some implementations, the supervisor P-unit 430 and other P-units 415 in the processor communicate via a private fabric 547. The supervisor P-unit 430 sends power management messages to other P-units 415 via a transmit (TX) mailbox 530 and receives messages from the other P-units via a receive (RX) mailbox 531. Each of the other P-units (such as P-unit 415, shown for simplicity) includes a TX mailbox 516 for transmitting messages and an RX mailbox 517 for receiving messages.

In some embodiments, the P-units 430, 415 include microcontrollers or processors for executing firmware 535, 536, respectively, to perform the power management operations described herein. For example, supervisor firmware (FW) 535 executed by supervisor p-unit 430 specifies operations such as transmission of messages sent to TX mailbox 430, and over the private fabric 547 to the RX mailbox 517 of p-unit 415. Here, the “mailbox” may refer to a specified register or memory location, or a driver executed in kernel space. Upon receiving the message, RX mailbox 417 may save the relevant portions of the message to a memory 518 (e.g., a local memory or a region in system memory), the contents of which are accessible by P-unit 415 executing its copy of the FW 536 (which may be the same as or different from the FW 535 executed by the supervisor P-unit 430).

In response to receiving the message, the P-unit 415 executing the firmware 536 confirms reception of the message by sending an Ack message to supervisor 430 via TX mailbox 516. The Ack message is communicated to RX mailbox 531 via fabric 547 and may be stored in memory 532 (e.g., a local memory or a region in system memory). The supervisor P-unit 430 (executing FW 535) accesses memory 532 to read and evaluate pending messages to determine the next course of action.

In various embodiments, supervisor p-unit 430 is accessible by other system components such as a global agent 555 (e.g., a platform supervisor agent such as a BMC) via public fabric 546. In some embodiments, public fabric 546 and private fabric 547 are the same fabric. In some embodiments, the supervisor p-unit 430 is also accessible by software drivers 550 (e.g., operable within the OS or other supervisory FW/SW 1070) via a primary fabric 545 and/or application programming interface (API) 540. In some embodiments, a single fabric is used instead of the three separate fabrics 545-547 shown in FIG. 5.

### Apparatus and Method for Performance-Focused Frequency Selection for Compute Blocks

As mentioned, in voltage regulator topologies that utilize a common input voltage to supply multiple intellectual property (IP) blocks with differing voltage/frequency operating points, excess power may be lost, either in the IP blocks themselves or in their individual voltage regulators sharing the common input voltage, resulting in reduced performance.

To address these limitations, embodiments of the invention limit the operating frequencies of some IP blocks such that their required minimum voltage is aligned to that of other IP blocks deemed more important or higher priority. The power delivery efficiencies for these “non-dominant” or lower priority IP blocks can thereby be improved within the finite power constraints of the product.

Embodiments of the invention described below implement voltage alignment, referred to as a “reverse VF lookup”. Some embodiments include a “curve shaping” table to allow the results of the reverse VF lookup method to be skewed in one direction or another based on IP operating frequency (e.g., to adjust for unique performance characteristics found in post silicon testing).

The algorithm in question allows for tunable frequency selection which considers the shared input voltage regulation scheme losses, and therefore minimizes those losses. Doing so delivers more optimal frequency assignment within a power-constrained budget, which in turn delivers higher frequencies and higher benchmark score performance visible to customers.

First, these embodiments perform operations to reduce losses in processors and SoCs in which a single input voltage is a) consumed directly by multiple IP blocks, with no voltage regulation element in the path (other than perhaps a power switch or gate), and/or b) consumed by multiple on-die downstream regulators of a linear type, which then output individual voltages to IP blocks based on corresponding frequency-voltage curves.

In some implementations, IP blocks are categorized and operated on as “types” and at least one IP block type is an “index” IP block. As used herein, an index IP block is an IP block type from which the voltages/frequencies of other IP blocks are determined. For example, if the index IP type is performance cores (P-cores), the other IP blocks have their relative frequencies and voltages assigned based on comparing their VF curves to that of the performance cores.

FIG. 6 illustrates one embodiment of an SoC 610 with power management circuitry 630 for implementing the techniques described herein. The power management circuitry 630 may include one or more microcontrollers or other type of processors which execute secure firmware such as P-code provided from BIOS 1670, an operating system, and/or other forms of privileged software or firmware. For example, the BIOS firmware may be provided from a secure non-volatile memory during the SoC boot sequence.

In the illustrated example, the SoC 610 includes multiple IP circuit blocks 601-603, each with local power management circuitry 621-623, respectively, for locally controlling the voltage and frequency applied to each respective IP circuit block 601-603. By way of example, and not limitation, IP circuit block 602 may include one or more performance cores (P-cores), such as P-cores 420-421 shown in FIG. 4; IP circuit block 602 may include one or more E-core clusters, such as E-core clusters 410-411; and IP circuit block 603 may include one or more graphics cores, such as graphics cores 407-408. One IP block may include an interconnect fabric (or portions thereof), a memory controller, and a plurality of input-output interfaces. Note that these are merely examples used for the purpose of illustration. The underlying principles of the invention are not limited to any particular types of IP blocks.

In some implementations, the local power management circuitry 621-623 associated with each respective IP block 601-603 may include the same circuitry or a subset of the circuitry as the power management circuitry 630. In this embodiment, for example, the local power management circuitry 621-623 may each include one or more microcontrollers which execute secure firmware such as P-code provided from BIOS 1670, an operating system, and/or other forms of privileged software or firmware. In one particular implementation, the power management circuitry 630 is in the same SoC package as the local power management circuitry 621-623 and may receive periodic telemetry updates from the local power management circuitry 621-623. The telemetry updates may include, for example, the current voltage/frequency of each IP block 601-603, as well as requests from one or more of the local power management circuitry 621-623 to adjust the current voltage/frequency. The SoC power management circuitry 630 uses this information to render package-wide power management decisions, scaling frequency and voltage as needed to keep the SoC 610 within specified power and thermal limits, and sending responses indicating the allowable maximum voltages/frequencies to the local power management circuitry 621-623, which implement the indicated voltages/frequencies on their respective IP blocks 601-603.

In one implementation, voltage/frequency (V/F) control circuitry 608 specifies the voltages and frequencies of each IP circuit block 601-603 in accordance with a set of per-IP voltage/frequency curves 634 by controlling an external voltage regulator 611 to provide the input voltage 600 to each of the IP blocks 601-603 and by directly transmitting control messages to local power management circuitry 621-623 associated with each IP circuit block 601-603, each of which may include or may be coupled to a local voltage regulation circuit (e.g., such as a linear voltage regulator, a linear dropout regulator, etc) and frequency/clock regulation circuitry.

In one embodiment, the per-IP V/F curves 634 are determined and fused into the SoC 610 at manufacture. Alternatively, or additionally, the fused values may be modified or replaced through the BIOS 1670 or using software utilities such as overclocking tools. In this implementation, a local non-volatile storage may be updated with the new values. Alternatively, or additionally, a volatile storage may be used and updated from the BIOS 1670 each time the SoC is reset.

In one particular implementation, table generation circuitry 635 uses the per-IP V/F curves to construct a voltage/frequency mapping table 638 which includes some number (N) of frequency points chosen along the operating range of allowable frequencies for the set of all IP block types under the regime. The table generation circuitry 635 first assigns a minimum voltage for each listed frequency for the index IP type. In the example illustrated in FIG. 6, IP circuit block 601 is the index IP type.

An example is provided in Table B below in the column labeled “Index IP Vₘᵢₙ”. From this Index IP Vₘᵢₙ, for each frequency row in the table, the table generation circuitry 635 performs a reverse VF lookup of that voltage into the voltage/frequency curve 634 for the other IP Types 602-603 (shown in the example table as Type A-Type Z). This is accomplished using any number of available array search techniques. Once the frequency of each IP Type corresponding to that table row's Index IP Vₘᵢₙ are found, they are entered into the table.

TABLE B

| Index | Index | FCap for IP | | FCap for IP |
|---|---|---|---|---|
| IP | IP | Type A (Reverse | | Type Z (Reverse |
| Frequency | Vₘᵢₙ | VF Lookup) | . . . | VF Lookup) |
| 5.0 GHz | 1.18 V | 4.0 GHz | . . . | 4.0 GHz |
| 4.0 GHz | 0.90 V | 3.6 GHz | . . . | 3.6 GHz |
| 3.0 GHz | 0.78 V | 2.8 GHz | . . . | 2.8 GHz |
| 2.5 GHz | 0.70 V | 2.5 GHz | . . . | 2.5 GHz |
| 2.0 GHz | 0.65 V | 2.2 GHz | . . . | 2.1 GHz |
| 1.2 GHz | 0.60 V | 1.6 GHz | . . . | 1.5 GHz |

Next, the values in the columns labeled “FCap for IP Type [x]” are “shaped” by multiplying them with a scalar value per frequency row. In one implementation, these scalar values are encoded in a separate table available to the table generation circuitry 635, such as Table C below. These scalar values may be determined, for example, using post silicon tuning methods, which discover flaws in the pure reverse VF lookup and patch them by giving up some power delivery efficiency for better matched co-operative IP frequencies.

TABLE C

| Index | FCap Scalar for | | FCap Scalar for |
|---|---|---|---|
| IP | IP Type A | | IP Type Z |
| Frequency | (Hard Coded) | . . . | (Hard Coded) |
| 5.0 GHz | 0.9 | . . . | 1.0 |
| 4.0 GHz | 1.0 | . . . | 1.0 |
| 3.0 GHz | 1.1 | . . . | 1.0 |
| 2.5 GHz | 1.0 | . . . | 1.2 |
| 2.0 GHz | 0.9 | . . . | 1.2 |
| 1.2 GHz | 1.0 | . . . | 1.2 |

After multiplying these scalars into the appropriate rows of the master table, the IP frequency/voltage mapping table 638 is complete. Now, when the V/F control circuitry 633 makes a frequency selection for the Index IP circuit block 601 based on its requested voltage and frequency, it uses the V/F mapping table 638 to efficiently determine what the appropriate maximum frequencies should be for all other types of IP circuit blocks 602-603 which are not of the Index IP type.

In one embodiment, when the system power constraints are such that the current workload is not limited by them, the power management circuitry 630 does not use the V/F mapping table 638 and associated techniques described herein, and instead assigns frequencies and voltages to each IP as they are requested and calculated.

A method in accordance with one embodiment of the invention is illustrated in FIG. 7. The method may be implemented on the various architectures described herein, but is not limited to any particular processor or system architecture.

Starting at 701, if the voltage/frequency of IP blocks is not being limited based on system power constraints, then at 710 voltage/frequency control is performed without using the voltage/frequency mapping table as described herein. Instead, the power management circuitry may allocate the voltages/frequencies in accordance with requests from the various IP blocks 601-603 and corresponding voltage/frequency curves 634 (e.g., stored in an operational performance point (OPP) table or other data structure).

If the voltage/frequency of IP blocks is being limited, as determined at 701, then at 702, a voltage/frequency mapping table (or other data structure) is constructed with frequency/voltage values for an index IP block type. As mentioned, these values may be determined from per-IP block voltage/frequency curves determined at manufacture. In some embodiments, the frequencies of the index IP block are used to identify corresponding voltages, which are then used to identify corresponding frequencies of the other IP blocks. Scaling factors may then be applied (e.g., as described above with respect to table C) to determine the mapped frequencies for the other IP blocks.

At 703, a reverse voltage/frequency lookup is performed based on the index IP block voltages to identify maximum frequency values (Fcap) for the other IP blocks. At 704, the Fcap values are shaped based on corresponding scalar values. In one implementation, these scalar values are encoded in a separate table, and may be determined, for example, using post silicon tuning methods, which discover flaws in the pure reverse VF lookup and patch them by giving up some power delivery efficiency for better matched cooperative IP block frequencies.

At 705, the voltage and frequency values of the other IP blocks are set based on the voltage and frequency set for the index IP block. For example, once the voltage/frequency mapping table is constructed, a table lookup may be performed to determine the corresponding voltages and frequencies for each IP block based on a current voltage/frequency of the index IP block.

While embodiments of invention have been described with reference to specific exemplary implementations, various modifications and changes may be made thereto without departing from the broader spirit and scope of the invention as set forth in the claims. The specification and drawings are, accordingly, to be regarded in an illustrative rather than a restrictive sense. For example, while specific types of cores are selected as index IP blocks, any form of IP block may be used as an index for other IP blocks in an SoC. Moreover, an SoC as described herein may include all IP blocks on a single die, or may be a multi-chip module (MCM) with a disaggregated architecture comprising a plurality of homogeneous dies (with the same set of IP blocks) or heterogeneous dies (with different IP blocks on different dies) integrated on a package.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

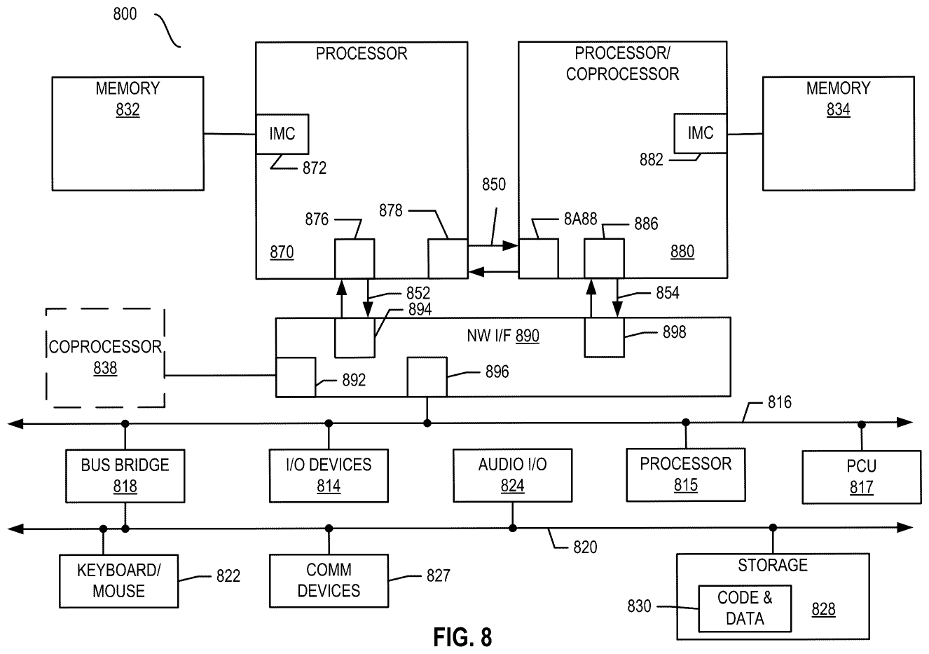

FIG. 8 illustrates embodiments of an exemplary system. Multiprocessor system 800 is a point-to-point interconnect system and includes a plurality of processors including a first processor 870 and a second processor 880 coupled via a point-to-point interconnect 850. In some embodiments, the first processor 870 and the second processor 880 are homogeneous. In some embodiments, first processor 870 and the second processor 880 are heterogenous.

Processors 870 and 880 are shown including integrated memory controller (IMC) units circuitry 872 and 882, respectively. Processor 870 also includes as part of its interconnect controller units point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via a high-performance interface 892. In some embodiments, the coprocessor 838 is a special-purpose processor, such as, for example, a high-throughput MIC processor, a network or communication processor, compression engine, graphics processor, GPGPU, embedded processor, or the like.

A shared cache (not shown) may be included in either processor 870, 880 or outside of both processors, yet connected with the processors via P-P interconnect, such that either or both processors' local cache information may be stored in the shared cache if a processor is placed into a low power mode.

Chipset 890 may be coupled to a first interconnect 816 via an interface 896. In some embodiments, first interconnect 816 may be a Peripheral Component Interconnect (PCI) interconnect, or an interconnect such as a PCI Express interconnect or another I/O interconnect. In some embodiments, one of the interconnects couples to a power control unit (PCU) 817, which may include circuitry, software, and/or firmware to perform power management operations with regard to the processors 870, 880 and/or co-processor 838. PCU 817 provides control information to a voltage regulator to cause the voltage regulator to generate the appropriate regulated voltage. PCU 817 also provides control information to control the operating voltage generated. In various embodiments, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other embodiments, power management operations to be performed by PCU 817 may be implemented externally to a processor, such as by way of a separate power management integrated circuit (PMIC) or another component external to the processor. In yet other embodiments, power management operations to be performed by PCU 817 may be implemented within BIOS or other system software.

Various I/O devices 814 may be coupled to first interconnect 816, along with an interconnect (bus) bridge 818 which couples first interconnect 816 to a second interconnect 820. In some embodiments, one or more additional processor(s) 815, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 816. In some embodiments, second interconnect 820 may be a low pin count (LPC) interconnect. Various devices may be coupled to second interconnect 820 including, for example, a keyboard and/or mouse 822, communication devices 827 and a storage unit circuitry 828. Storage unit circuitry 828 may be a disk drive or other mass storage device which may include instructions/code and data 830, in some embodiments. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core, Processor, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

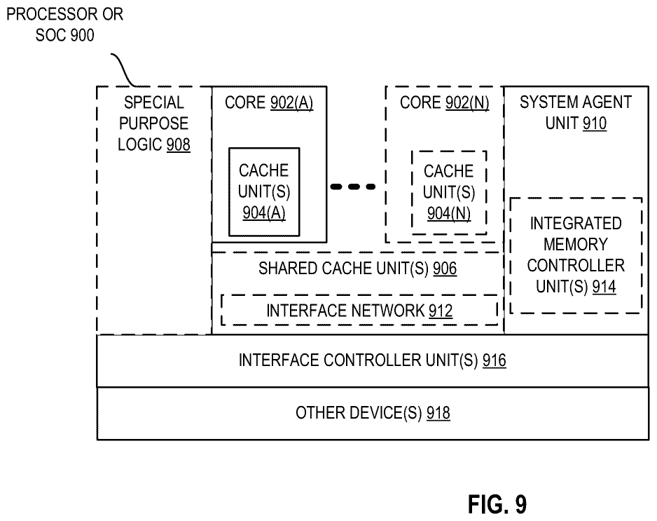

FIG. 9 illustrates a block diagram of embodiments of a processor 900 that may have more than one core, may have an integrated memory controller, and may have integrated graphics. The solid lined boxes illustrate a processor 900 with a single core 902A, a system agent 910, a set of one or more interconnect controller units circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

A memory hierarchy includes one or more levels of cache unit(s) circuitry 904(A)-(N) within the cores 902(A)-(N), a set of one or more shared cache units circuitry 906, and external memory (not shown) coupled to the set of integrated memory controller units circuitry 914. The set of one or more shared cache units circuitry 906 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 912 interconnects the special purpose logic 908 (e.g., integrated graphics logic), the set of shared cache units circuitry 906, and the system agent unit circuitry 910, alternative embodiments use any number of well-known techniques for interconnecting such units. In some embodiments, coherency is maintained between one or more of the shared cache units circuitry 906 and cores 902(A)-(N).

In some embodiments, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous or heterogeneous in terms of architecture instruction set; that is, two or more of the cores 902(A)-(N) may be capable of executing the same instruction set, while other cores may be capable of executing only a subset of that instruction set or a different instruction set.

### Exemplary Core Architectures

### In-Order and Out-of-Order Core Block Diagram

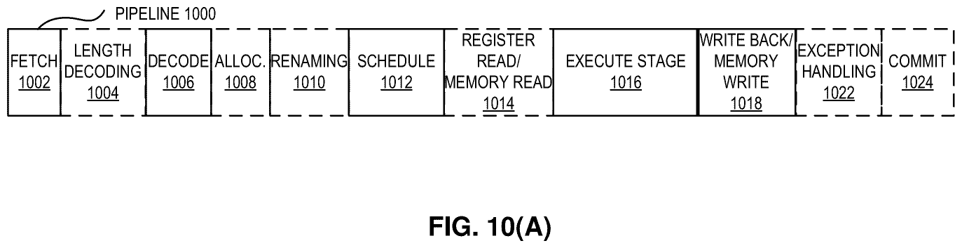

FIG. 10(A) is a block diagram illustrating both an exemplary in-order pipeline and an exemplary register renaming, out-of-order issue/execution pipeline according to embodiments of the invention. FIG. 10(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 10(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10(A), a processor pipeline 1000 includes a fetch stage 1002, an optional length decode stage 1004, a decode stage 1006, an optional allocation stage 1008, an optional renaming stage 1010, a scheduling (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, during the decode stage 1006, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 1006 and the register read/memory read stage 1014 may be combined into one pipeline stage. In one embodiment, during the execute stage 1016, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 1000 as follows: 1) the instruction fetch 1038 performs the fetch and length decoding stages 1002 and 1004; 2) the decode unit circuitry 1040 performs the decode stage 1006; 3) the rename/allocator unit circuitry 1052 performs the allocation stage 1008 and renaming stage 1010; 4) the scheduler unit(s) circuitry 1056 performs the schedule stage 1012; 5) the physical register file(s) unit(s) circuitry 1058 and the memory unit circuitry 1070 perform the register read/memory read stage 1014; the execution cluster 1060 perform the execute stage 1016; 6) the memory unit circuitry 1070 and the physical register file(s) unit(s) circuitry 1058 perform the write back/memory write stage 1018; 7) various units (unit circuitry) may be involved in the exception handling stage 1022; and 8) the retirement unit circuitry 1054 and the physical register file(s) unit(s) circuitry 1058 perform the commit stage 1024.

FIG. 10(B) shows processor core 1090 including front-end unit circuitry 1030 coupled to an execution engine unit circuitry 1050, and both are coupled to a memory unit circuitry 1070. The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction unit circuitry 1032 coupled to an instruction cache unit circuitry 1034, which is coupled to an instruction translation lookaside buffer (TLB) 1036, which is coupled to instruction fetch unit circuitry 1038, which is coupled to decode unit circuitry 1040. In one embodiment, the instruction cache unit circuitry 1034 is included in the memory unit circuitry 1070 rather than the front-end unit circuitry 1030. The decode unit circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 1040 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 1040 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1090 includes a microcode ROM (not shown) or other medium that stores microcode for certain macroinstructions (e.g., in decode unit circuitry 1040 or otherwise within the front end unit circuitry 1030). In one embodiment, the decode unit circuitry 1040 includes a micro-operation (micro-op) or operation cache (not shown) to hold/cache decoded operations, micro-tags, or micro-operations generated during the decode or other stages of the processor pipeline 1000. The decode unit circuitry 1040 may be coupled to rename/allocator unit circuitry 1052 in the execution engine unit circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some embodiments, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 1058 includes vector registers unit circuitry, writemask registers unit circuitry, and scalar register unit circuitry. These register units may provide architectural vector registers, vector mask registers, general-purpose registers, etc. The physical register file(s) unit(s) circuitry 1058 is overlapped by the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution units circuitry 1062 and a set of one or more memory access circuitry 1064. The execution units circuitry 1062 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 1056, physical register file(s) unit(s) circuitry 1058, and execution cluster(s) 1060 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 1064). It should also be understood that where separate pipelines are used, one or more of these pipelines may be out-of-order issue/execution and the rest in-order.

In some embodiments, the execution engine unit circuitry 1050 may perform load store unit (LSU) address/data pipelining to an Advanced Microcontroller Bus (AHB) interface (not shown), and address phase and writeback, data phase load, store, and branches.

The set of memory access circuitry 1064 is coupled to the memory unit circuitry 1070, which includes data TLB unit circuitry 1072 coupled to a data cache circuitry 1074 coupled to a level 2 (L2) cache circuitry 1076. In one exemplary embodiment, the memory access units circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to a level 2 (L2) cache unit circuitry 1076 in the memory unit circuitry 1070. In one embodiment, the instruction cache 1034 and the data cache 1074 are combined into a single instruction and data cache (not shown) in L2 cache unit circuitry 1076, a level 3 (L3) cache unit circuitry (not shown), and/or main memory. The L2 cache unit circuitry 1076 is coupled to one or more other levels of cache and eventually to a main memory.

The core 1090 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 1090 includes logic to support a packed data instruction set extension (e.g., AVX1, AVX2), thereby allowing the operations used by many multimedia applications to be performed using packed data.

### Exemplary Execution Unit(s) Circuitry

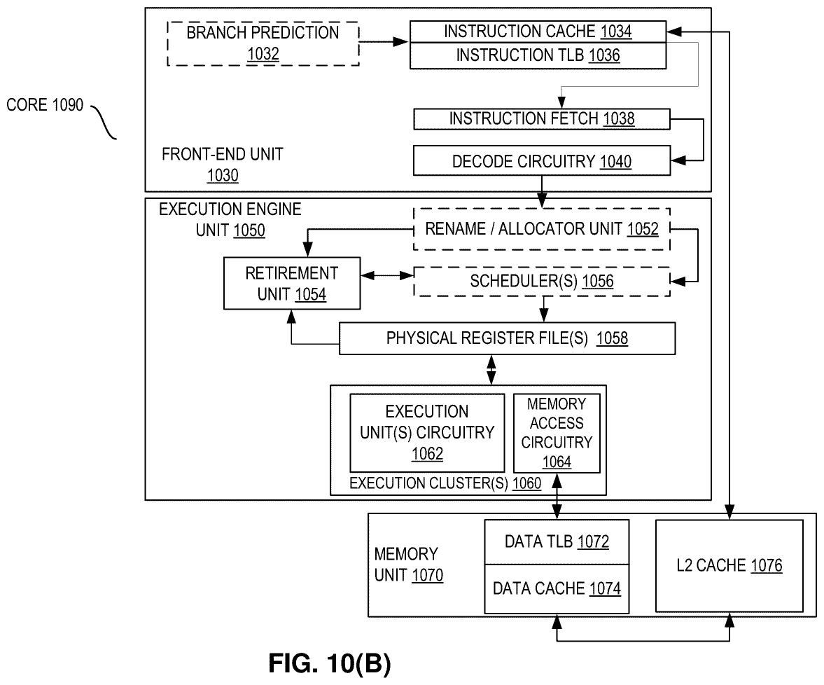

FIG. 11 illustrates embodiments of execution unit(s) circuitry, such as execution unit(s) circuitry 1062 of FIG. 10(B). As illustrated, execution unit(s) circuitry 1062 may include one or more ALU circuits 1101, vector/SIMD unit circuits 1103, load/store unit circuits 1105, and/or branch/jump unit circuits 1107. ALU circuits 1101 perform integer arithmetic and/or Boolean operations. Vector/SIMD unit circuits 1103 perform vector/SIMD operations on packed data (such as SIMD/vector registers). Load/store unit circuits 1105 execute load and store instructions to load data from memory into registers or store from registers to memory. Load/store unit circuits 1105 may also generate addresses. Branch/jump unit circuits 1107 cause a branch or jump to a memory address depending on the instruction. Floating-point unit (FPU) circuits 1109 perform floating-point arithmetic. The width of the execution unit(s) circuitry 1062 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

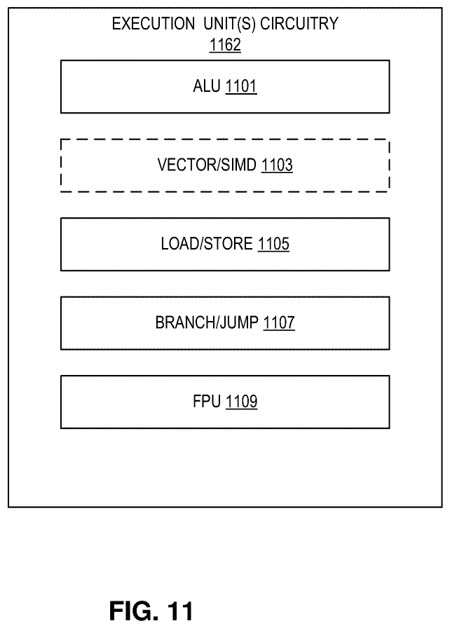

FIG. 12 is a block diagram of a register architecture 1200 according to some embodiments. As illustrated, there are vector/SIMD registers 1210 that vary from 128-bit to 1,024 bits width. In some embodiments, the vector/SIMD registers 1210 are physically 512-bits and, depending upon the mapping, only some of the lower bits are used. For example, in some embodiments, the vector/SIMD registers 1210 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 1200 includes writemask/predicate registers 1215. For example, in some embodiments, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 1215 corresponds to a data element position of the destination. In other embodiments, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 1200 includes scalar floating-point register 1245 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some embodiments, the one or more flag registers 1240 are called program status and control registers.

Segment registers 1220 contain segment points for use in accessing memory. In some embodiments, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 1170, 1180, 1138, 1115, and/or 1200) and the characteristics of a currently executing task. Debug registers 1250 control and allow for the monitoring of a processor or core's debugging operations.

Memory management registers 1265 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

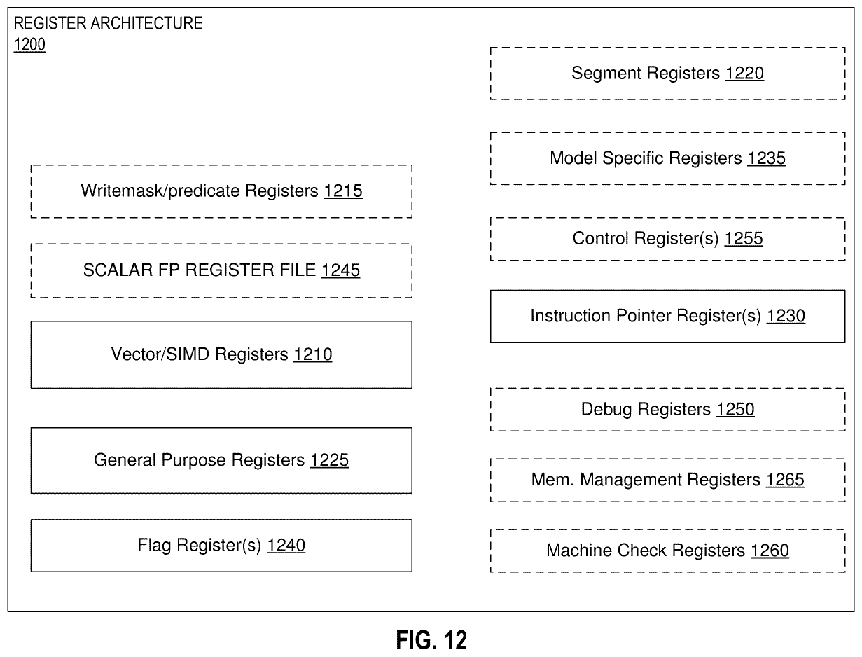

FIG. 13 illustrates embodiments of an instruction format. As illustrated, an instruction may include multiple components including, but not limited to, one or more fields for: one or more prefixes 1301, an opcode 1303, addressing information 1305 (e.g., register identifiers, memory addressing information, etc.), a displacement value 1307, and/or an immediate 1309. Note that some instructions utilize some or all of the fields of the format whereas others may only use the field for the opcode 1303. In some embodiments, the order illustrated is the order in which these fields are to be encoded, however, it should be appreciated that in other embodiments these fields may be encoded in a different order, combined, etc.

The prefix(es) field(s) 1301, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1303 is used to at least partially define the operation to be performed upon a decoding of the instruction. In some embodiments, a primary opcode encoded in the opcode field 1303 is 1, 2, or 3 bytes in length. In other embodiments, a primary opcode can be a different length. An additional 3-bit opcode field is sometimes encoded in another field.

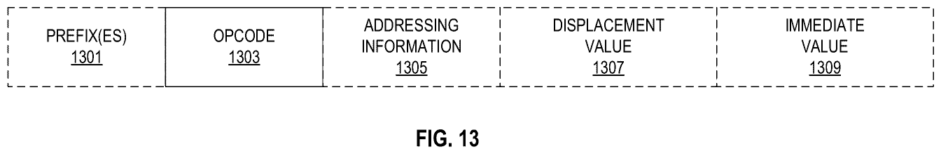

The addressing field 1305 is used to address one or more operands of the instruction, such as a location in memory or one or more registers. FIG. 14 illustrates embodiments of the addressing field 1305. In this illustration, an optional ModR/M byte 1402 and an optional Scale, Index, Base (SIB) byte 1404 are shown. The ModR/M byte 1402 and the SIB byte 1404 are used to encode up to two operands of an instruction, each of which is a direct register or effective memory address. Note that each of these fields are optional in that not all instructions include one or more of these fields. The MOD R/M byte 1402 includes a MOD field 1442, a register field 1444, and R/M field 1446.

The content of the MOD field 1442 distinguishes between memory access and non-memory access modes. In some embodiments, when the MOD field 1442 has a value of b11, a register-direct addressing mode is utilized, and otherwise register-indirect addressing is used.

The register field 1444 may encode either the destination register operand or a source register operand, or may encode an opcode extension and not be used to encode any instruction operand. The content of register index field 1444, directly or through address generation, specifies the locations of a source or destination operand (either in a register or in memory). In some embodiments, the register field 1444 is supplemented with an additional bit from a prefix (e.g., prefix 1301) to allow for greater addressing.

The R/M field 1446 may be used to encode an instruction operand that references a memory address, or may be used to encode either the destination register operand or a source register operand. Note the R/M field 1446 may be combined with the MOD field 1442 to dictate an addressing mode in some embodiments.

The SIB byte 1404 includes a scale field 1452, an index field 1454, and a base field 1456 to be used in the generation of an address. The scale field 1452 indicates scaling factor. The index field 1454 specifies an index register to use. In some embodiments, the index field 1454 is supplemented with an additional bit from a prefix (e.g., prefix 601) to allow for greater addressing. The base field 1456 specifies a base register to use. In some embodiments, the base field 1456 is supplemented with an additional bit from a prefix (e.g., prefix 1301) to allow for greater addressing. In practice, the content of the scale field 1452 allows for the scaling of the content of the index field 1454 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 1307 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 1307.

In some embodiments, an immediate field 1309 specifies an immediate for the instruction. An immediate may be encoded as a 1-byte value, a 2-byte value, a 4-byte value, etc.

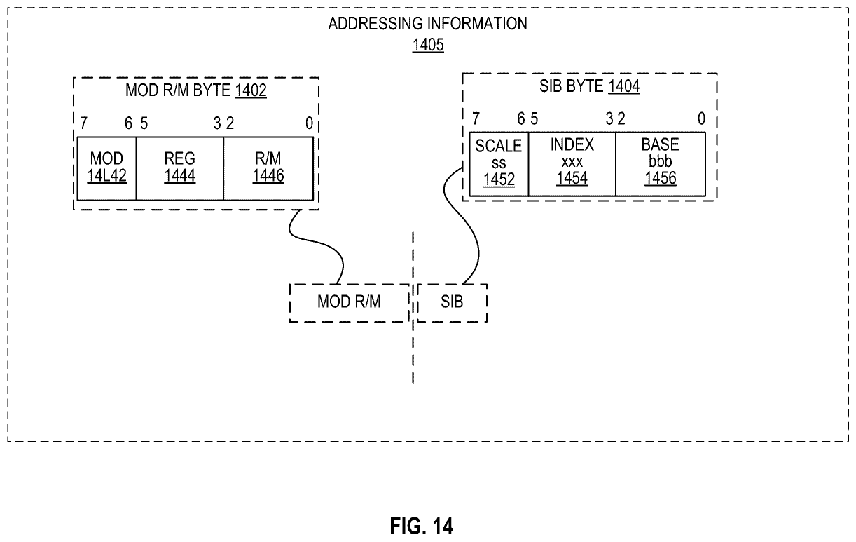

FIG. 15 illustrates embodiments of a first prefix 1301(A). In some embodiments, the first prefix 1301(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1301(A) may specify up to three registers using 3-bit fields depending on the format: 1) using the reg field 1444 and the R/M field 1446 of the Mod R/M byte 702; 2) using the Mod R/M byte 1402 with the SIB byte 1404 including using the reg field 1444 and the base field 1456 and index field 1454; or 3) using the register field of an opcode.

In the first prefix 1301(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 1301(A), bit position 2 (R) may an extension of the MOD R/M reg field 1444 and may be used to modify the ModR/M reg field 1444 when that field encodes a general purpose register, a 64-bit packed data register (e.g., a SSE register), or a control or debug register. R is ignored when Mod R/M byte 1402 specifies other registers or defines an extended opcode.

Bit position 1 (X) X bit may modify the SIB byte index field 1454.

Bit position B (B) B may modify the base in the Mod R/M R/M field 1446 or the SIB byte base field 1456; or it may modify the opcode register field used for accessing general purpose registers (e.g., general purpose registers 525).

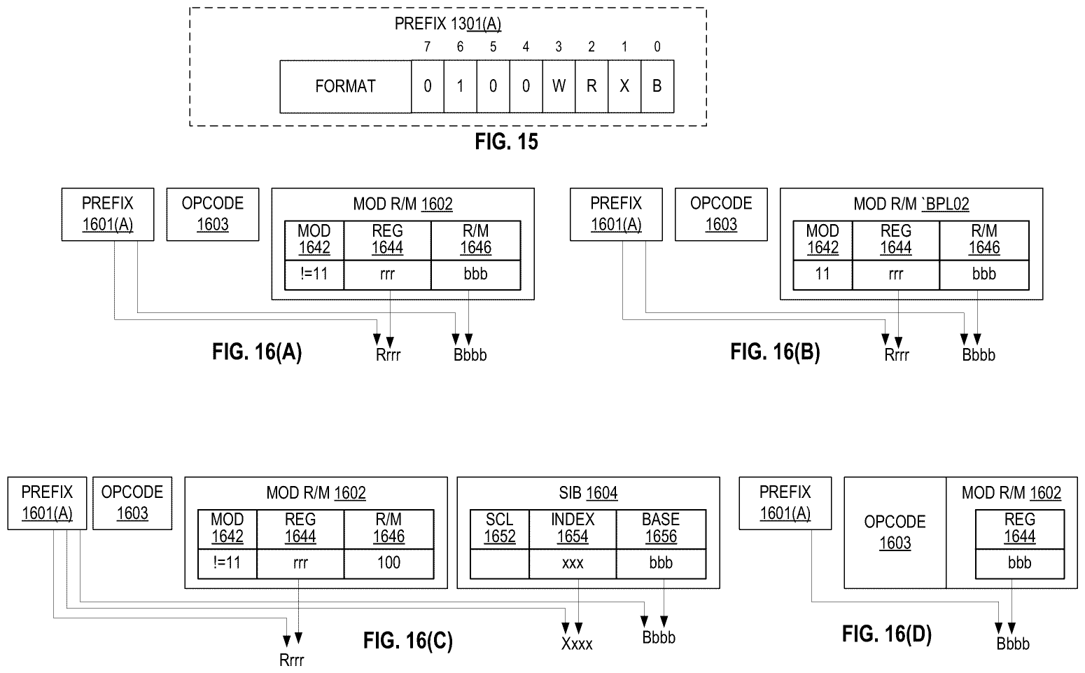

FIGS. 16(A)-(D) illustrate embodiments of how the R, X, and B fields of the first prefix 1301(A) are used. FIG. 16(A) illustrates R and B from the first prefix 1301(A) being used to extend the reg field 744 and R/M field 746 of the MOD R/M byte 702 when the SIB byte 704 is not used for memory addressing. FIG. 16(B) illustrates R and B from the first prefix 1301(A) being used to extend the reg field 744 and R/M field 746 of the MOD R/M byte 702 when the SIB byte 704 is not used (register-register addressing). FIG. 16(C) illustrates R, X, and B from the first prefix 1301(A) being used to extend the reg field 744 of the MOD R/M byte 702 and the index field 754 and base field 756 when the SIB byte 7 04 being used for memory addressing. FIG. 16(D) illustrates B from the first prefix 1301(A) being used to extend the reg field 744 of the MOD R/M byte 702 when a register is encoded in the opcode 603.

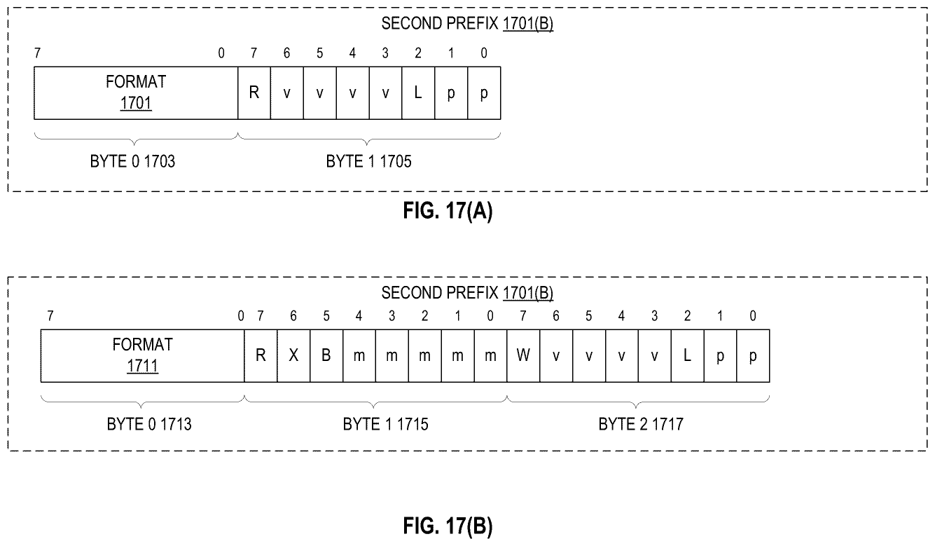

FIGS. 17(A)-(B) illustrate embodiments of a second prefix 1701(B). In some embodiments, the second prefix 1701(B) is an embodiment of a VEX prefix. The second prefix 1701(B) encoding allows instructions to have more than two operands, and allows SIMD vector registers (e.g., vector/SIMD registers 510) to be longer than 64-bits (e.g., 128-bit and 256-bit). The use of the second prefix 1701(B) provides for three-operand (or more) syntax. For example, previous two-operand instructions performed operations such as A=A+B, which overwrites a source operand. The use of the second prefix 1701(B) enables operands to perform nondestructive operations such as A=B+C.

In some embodiments, the second prefix 1301(B) comes in two forms—a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 17(A) illustrates embodiments of a two-byte form of the second prefix 1301(B). In one example, a format field 1001 (byte 0 1003) contains the value C5H. In one example, byte 1 1005 includes a “R” value in bit[7]. This value is the complement of the same value of the first prefix 1301(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 1309 are then used to encode the third source register operand.

FIG. 17(B) illustrates embodiments of a three-byte form of the second prefix 601(B). in one example, a format field 2011 (byte 0 2013) contains the value C4H. Byte 1 2015 includes in bits[7:5] “R,” “X,” and “B” which are the complements of the same values of the first prefix 601(A). Bits[4:0] of byte 1 2015 (shown as mmmmm) include content to encode, as need, one or more implied leading opcode bytes. For example, 00001 implies a OFH leading opcode, 00010 implies a 0F38H leading opcode, 00011 implies a leading 0F3AH opcode, etc.

Bit[7] of byte 2 2017 is used similar to W of the first prefix 601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

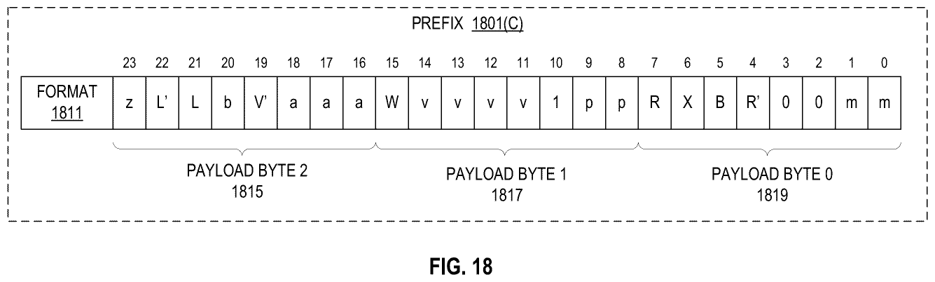

FIG. 18 illustrates embodiments of a third prefix 1301(C). In some embodiments, the first prefix 1301(A) is an embodiment of an EVEX prefix. The third prefix 1301(C) is a four-byte prefix.

The third prefix 1301(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 12) or predication utilize this prefix. Opmask register allow for conditional processing or selection control. Opmask instructions, whose source/destination operands are opmask registers and treat the content of an opmask register as a single value, are encoded using the second prefix 1301(B).

The third prefix 1301(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1301(C) is a format field 2111 that has a value, in one example, of 62H. Subsequent bytes are referred to as payload bytes 2115, 2116, and 2119 and collectively form a 24-bit value of P[23:0] providing specific capability in the form of one or more fields (detailed herein).

In some embodiments, P[1:0] of payload byte 2119 are identical to the low two mmmmm bits. P[3:2] are reserved in some embodiments. Bit P[4] (R′) allows access to the high 16 vector register set when combined with P[7] and the ModR/M reg field 1444. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1444 and ModR/M R/M field 1446. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 1215). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in Instructions using the third prefix 1601(C) are detailed in the following tables.

TABLE 1
32-Register Support in 64-bit Mode

| | | | | REG. | COMMON |
|---|---|---|---|---|---|
| | 4 | 3 | [2:0] | TYPE | USAGES |
| REG | R′ | R | ModR/M | GPR, | Destination or |
| | | | reg | Vector | Source |
| VVVV | V′ | vvvv | | GPR, | 2nd Source or |
| | | | | Vector | Destination |
| RM | X | B | ModR/M | GPR, | 1st Source or |
| | | | R/M | Vector | Destination |
| BASE | 0 | B | ModR/M | GPR | Memory |
| | | | R/M | | addressing |
| INDEX | 0 | X | SIB.index | GPR | Memory |
| | | | | | addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory |
| | | | addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k01-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

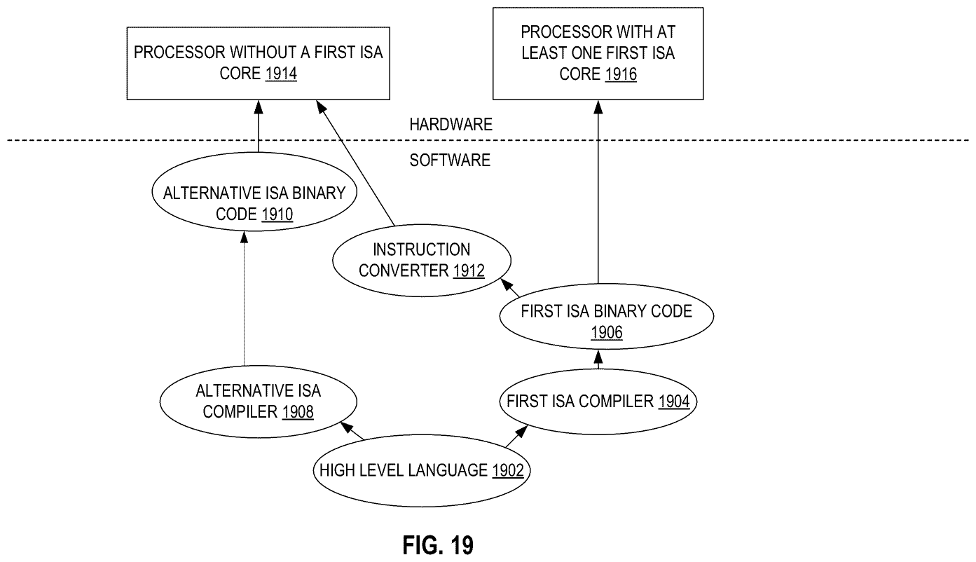

FIG. 19 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 19 shows a program in a high level language 1902 may be compiled using a first ISA compiler 1904 to generate first ISA binary code 1906 that may be natively executed by a processor with at least one first instruction set core 1916. The processor with at least one first ISA instruction set core 1916 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1904 represents a compiler that is operable to generate first ISA a binary code 1906 (e.g., object code) that can, with or without additional linkage processing, be executed on the processor with at least one first ISA instruction set core 1916.

Similarly, FIG. 19 shows the program in the high level language 1902 may be compiled using an alternative instruction set compiler 1908 to generate alternative instruction set binary code 1910 that may be natively executed by a processor without a first ISA instruction set core 1914. The instruction converter 1912 is used to convert the first ISA binary code 1906 into code that may be natively executed by the processor without a first ISA instruction set core 1914. This converted code is not likely to be the same as the alternative instruction set binary code 1910 because an instruction converter capable of this is difficult to make; however, the converted code will accomplish the general operation and be made up of instructions from the alternative instruction set. Thus, the instruction converter 1912 represents software, firmware, hardware, or a combination thereof that, through emulation, simulation or any other process, allows a processor or other electronic device that does not have a first ISA instruction set processor or core to execute the first ISA binary code 1906.

### EXAMPLES

The following are example implementations of different embodiments of the invention.

Example 1. A processor, comprising: a plurality of different types of intellectual property (IP) circuit blocks including a first type of IP circuit blocks and at least a second type of IP circuit blocks; power management circuitry to perform operations to determine voltages and frequencies at which to operate the plurality of different types of IP circuit blocks, the operations including: determining a plurality of voltage/frequency combinations for the first type of IP circuit blocks based on stored voltage/frequency curve data; determining maximum frequency values for the second type of IP circuit blocks corresponding to the plurality of voltage/frequency combinations, the maximum frequency values based on the stored voltage/frequency curve data; adjusting one or more of the maximum frequency values based on one or more corresponding stored scalar values to determine final maximum frequency values; causing the first type of IP circuit blocks to operate at one of the plurality of voltage/frequency combinations and responsively causing the second type of IP circuit blocks to operate at a corresponding final maximum frequency value.

Example 2. The processor of example 1 wherein the first type of IP circuit blocks comprises performance cores and wherein the second type of IP circuit blocks comprise efficiency cores, graphics processing cores, interconnect circuitry, memory controllers, or input-output controllers.

Example 3. The processor of examples 1 or 2 wherein adjusting one or more of the maximum frequency values further comprises multiplying the one or more maximum frequency values by the corresponding stored scalar values to generate the final maximum frequency values.

Example 4. The processor of any of examples 1 to 3 wherein causing the first type of IP circuit blocks to operate at one of the plurality of voltage/frequency combinations further comprises transmitting a control message to one or more local power manager circuits associated with the first type of IP circuit blocks, the one or more local power manager circuits to cause the first type of IP circuit blocks to operate at one of the plurality of voltage/frequency combinations.

Example 5. The processor of any of examples 1 to 4 wherein the scalar values comprise predetermined values determined using post silicon tuning and stored in a non-volatile memory of the processor.

Example 6. The processor of any of examples 1 to 5 further comprising: one or more additional types of IP circuit blocks, wherein the power management circuitry is to perform additional operations to determine voltages and frequencies at which to operate the one or more additional types of IP circuit blocks, the additional operations including: determining additional maximum frequency values for the one or more additional types of IP circuit blocks corresponding to the plurality of voltage/frequency combinations, the additional maximum frequency values based on the stored voltage/frequency curve data; adjusting one or more of the additional maximum frequency values based on one or more corresponding stored scalar values to determine final additional maximum frequency values; responsively causing the one or more additional types of IP circuit blocks to operate at one of the final additional maximum frequency values corresponding to the one of the plurality of voltage/frequency combinations at which the first type of IP circuit blocks are to operate.

Example 7. The processor of any of examples 1 to 6 wherein the power management circuitry is to control an external voltage regulator to supply a voltage to the plurality of different types of IP circuit blocks in accordance with the one of the plurality of voltage/frequency combinations at which the first type of IP circuit blocks are to operate.

Example 8. A method comprising: performing operations by power management circuitry to determine voltages and frequencies at which to operate a plurality of different types of IP circuit blocks, including a first type of IP circuit blocks and at least a second type of IP circuit blocks, the operations including: determining a plurality of voltage/frequency combinations for the first type of IP circuit blocks based on stored voltage/frequency curve data; determining maximum frequency values for the second type of IP circuit blocks corresponding to the plurality of voltage/frequency combinations, the maximum frequency values based on the stored voltage/frequency curve data; adjusting one or more of the maximum frequency values based on one or more corresponding stored scalar values to determine final maximum frequency values; causing the first type of IP circuit blocks to operate at one of the plurality of voltage/frequency combinations and responsively causing the second type of IP circuit blocks to operate at a corresponding final maximum frequency value.

Example 9. The method of example 8 wherein the first type of IP circuit blocks comprises performance cores and wherein the second type of IP circuit blocks comprise efficiency cores, graphics processing cores, interconnect circuitry, memory controllers, or input-output controllers.

Example 10. The method of examples 8 or 9 wherein adjusting one or more of the maximum frequency values further comprises multiplying the one or more maximum frequency values by the corresponding stored scalar values to generate the final maximum frequency values.

Example 11. The method of any of examples 8 to 10 wherein causing the first type of IP circuit blocks to operate at one of the plurality of voltage/frequency combinations further comprises transmitting a control message to one or more local power manager circuits associated with the first type of IP circuit blocks, the one or more local power manager circuits to cause the first type of IP circuit blocks to operate at one of the plurality of voltage/frequency combinations.

Example 12. The method of any of examples 8 to 11 wherein the scalar values comprise predetermined values determined using post silicon tuning and stored in a non-volatile memory.

Example 13. The method of any of examples 8 to 12 further comprising: determining additional maximum frequency values for one or more additional types of IP circuit blocks corresponding to the plurality of voltage/frequency combinations, the additional maximum frequency values based on the stored voltage/frequency curve data; adjusting one or more of the additional maximum frequency values based on one or more corresponding stored scalar values to determine final additional maximum frequency values; responsively causing the one or more additional types of IP circuit blocks to operate at one of the final additional maximum frequency values corresponding to the one of the plurality of voltage/frequency combinations at which the first type of IP circuit blocks are to operate.

Example 14. The method of any of claims 8 to 13 wherein the power management circuitry is to control an external voltage regulator to supply a voltage to the plurality of different types of IP circuit blocks in accordance with the one of the plurality of voltage/frequency combinations at which the first type of IP circuit blocks are to operate.

Example 15. A machine-readable medium having program code stored thereon which, when executed by a machine, causes the machine to perform the operations of: performing operations by power management circuitry to determine voltages and frequencies at which to operate a plurality of different types of IP circuit blocks, including a first type of IP circuit blocks and at least a second type of IP circuit blocks, the operations including: determining a plurality of voltage/frequency combinations for the first type of IP circuit blocks based on stored voltage/frequency curve data; determining maximum frequency values for the second type of IP circuit blocks corresponding to the plurality of voltage/frequency combinations, the maximum frequency values based on the stored voltage/frequency curve data; adjusting one or more of the maximum frequency values based on one or more corresponding stored scalar values to determine final maximum frequency values; causing the first type of IP circuit blocks to operate at one of the plurality of voltage/frequency combinations and responsively causing the second type of IP circuit blocks to operate at a corresponding final maximum frequency value.

Example 16. The machine-readable medium of example 15 wherein the first type of IP circuit blocks comprises performance cores and wherein the second type of IP circuit blocks comprise efficiency cores, graphics processing cores, interconnect circuitry, memory controllers, or input-output controllers.

Example 17. The machine-readable medium of examples 15 or 16 wherein adjusting one or more of the maximum frequency values further comprises multiplying the one or more maximum frequency values by the corresponding stored scalar values to generate the final maximum frequency values.

Example 18. The machine-readable medium of any of examples 15 to 17 wherein causing the first type of IP circuit blocks to operate at one of the plurality of voltage/frequency combinations further comprises transmitting a control message to one or more local power manager circuits associated with the first type of IP circuit blocks, the one or more local power manager circuits to cause the first type of IP circuit blocks to operate at one of the plurality of voltage/frequency combinations.

Example 19. The machine-readable medium of any of examples 15 to 18 wherein the scalar values comprise predetermined values determined using post silicon tuning and stored in a non-volatile memory.

Example 20. The machine-readable medium of any of examples 15 to 19 further comprising: determining additional maximum frequency values for one or more additional types of IP circuit blocks corresponding to the plurality of voltage/frequency combinations, the additional maximum frequency values based on the stored voltage/frequency curve data; adjusting one or more of the additional maximum frequency values based on one or more corresponding stored scalar values to determine final additional maximum frequency values; responsively causing the one or more additional types of IP circuit blocks to operate at one of the final additional maximum frequency values corresponding to the one of the plurality of voltage/frequency combinations at which the first type of IP circuit blocks are to operate.

Example 21. The machine-readable medium of any of examples 15 to 20 wherein the power management circuitry is to control an external voltage regulator to supply a voltage to the plurality of different types of IP circuit blocks in accordance with the one of the plurality of voltage/frequency combinations at which the first type of IP circuit blocks are to operate.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
a plurality of intellectual property (IP) circuit blocks including a first type of IP circuit block and at least a second type of IP circuit blocks; and
power management circuitry to perform operations to determine voltages and frequencies at which to operate the plurality of IP circuit blocks, the operations including:
determining a plurality of voltage/frequency combinations for the first type of IP circuit block based on stored voltage/frequency curve data;
determining maximum frequency values for the second type of IP circuit blocks corresponding to one or more of the plurality of voltage/frequency combinations, the maximum frequency values based on the stored voltage/frequency curve data;
adjusting one or more of the maximum frequency values based on one or more corresponding stored scalar values to determine final maximum frequency values for each of the second type of IP circuit blocks; and
causing the first type of IP circuit blocks to operate at one of the plurality of voltage/frequency combinations and responsively causing one or more of the second type of IP circuit blocks to operate at a corresponding final maximum frequency value.

2. The processor of claim 1 wherein the first type of IP circuit block comprises an IP block including performance cores and wherein the second type of IP circuit blocks comprise at least one of: efficiency cores, graphics processing cores, interconnect circuitry, memory controllers, and input-output controllers.

3. The processor of claim 1 wherein adjusting one or more of the maximum frequency values further comprises multiplying one or more of the maximum frequency values by the corresponding stored scalar values to generate the final maximum frequency values.

4. The processor of claim 1 wherein causing the first type of IP circuit block to operate at one of the plurality of voltage/frequency combinations further comprises transmitting a control message to one or more local power manager circuits associated with the first type of IP circuit block, the one or more local power manager circuits to cause the first type of IP circuit block to operate at one of the plurality of voltage/frequency combinations.

5. The processor of claim 1 wherein the scalar values comprise predetermined values determined by post silicon tuning and stored in a non-volatile memory.

6. The processor of claim 1 further comprising:
one or more additional types of IP circuit blocks, wherein the power management circuitry is to perform additional operations to determine voltages and frequencies at which to operate the one or more additional types of IP circuit blocks, the additional operations including:
determining additional maximum frequency values for the one or more additional types of IP circuit blocks corresponding to the plurality of voltage/frequency combinations, the additional maximum frequency values based on the stored voltage/frequency curve data;
adjusting one or more of the additional maximum frequency values based on one or more corresponding stored scalar values to determine additional final maximum frequency values; and
causing the one or more additional types of IP circuit blocks to operate at one of the additional final maximum frequency values corresponding to the one of the plurality of voltage/frequency combinations at which the first type of IP circuit blocks are to operate.

7. The processor of claim 1 wherein the power management circuitry is to control an external voltage regulator to supply a voltage to the plurality of different types of IP circuit blocks in accordance with the one of the plurality of voltage/frequency combinations at which the first type of IP circuit blocks are to operate.

8. A method comprising:
performing operations by power management circuitry to determine voltages and frequencies at which to operate a plurality of different types of IP circuit blocks, including a first type of IP circuit blocks and at least a second type of IP circuit blocks, the operations including:
determining a plurality of voltage/frequency combinations for the first type of IP circuit blocks based on stored voltage/frequency curve data;
determining maximum frequency values for the second type of IP circuit blocks corresponding to the plurality of voltage/frequency combinations, the maximum frequency values based on the stored voltage/frequency curve data;
adjusting one or more of the maximum frequency values based on one or more corresponding stored scalar values to determine final maximum frequency values; and
causing the first type of IP circuit blocks to operate at one of the plurality of voltage/frequency combinations and responsively causing the second type of IP circuit blocks to operate at a corresponding final maximum frequency value.

9. The method of claim 8 wherein the first type of IP circuit blocks comprises performance cores and wherein the second type of IP circuit blocks comprise efficiency cores, graphics processing cores, interconnect circuitry, memory controllers, or input-output controllers.

10. The method of claim 8 wherein adjusting one or more of the maximum frequency values further comprises multiplying the one or more maximum frequency values by the corresponding stored scalar values to generate the final maximum frequency values.

11. The method of claim 8 wherein causing the first type of IP circuit blocks to operate at one of the plurality of voltage/frequency combinations further comprises transmitting a control message to one or more local power manager circuits associated with the first type of IP circuit blocks, the one or more local power manager circuits to cause the first type of IP circuit blocks to operate at one of the plurality of voltage/frequency combinations.

12. The method of claim 8 wherein the scalar values comprise predetermined values determined using post silicon tuning and stored in a non-volatile memory.

13. The method of claim 8 further comprising:
determining additional maximum frequency values for one or more additional types of IP circuit blocks corresponding to the plurality of voltage/frequency combinations, the additional maximum frequency values based on the stored voltage/frequency curve data;
adjusting one or more of the additional maximum frequency values based on one or more corresponding stored scalar values to determine final additional maximum frequency values; and
causing the one or more additional types of IP circuit blocks to operate at one of the final additional maximum frequency values corresponding to the one of the plurality of voltage/frequency combinations at which the first type of IP circuit blocks are to operate.

14. The method of claim 8 wherein the power management circuitry is to control an external voltage regulator to supply a voltage to the plurality of different types of IP circuit blocks in accordance with the one of the plurality of voltage/frequency combinations at which the first type of IP circuit blocks are to operate.

15. A machine-readable medium having program code stored thereon which, when executed by a machine, causes the machine to perform the operations of:
determining a plurality of voltage/frequency combinations for a first type of IP circuit blocks based on stored voltage/frequency curve data;
determining maximum frequency values for a second type of IP circuit blocks corresponding to the plurality of voltage/frequency combinations, the maximum frequency values based on the stored voltage/frequency curve data;
adjusting one or more of the maximum frequency values based on one or more corresponding stored scalar values to determine final maximum frequency values; and
causing the first type of IP circuit blocks to operate at one of the plurality of voltage/frequency combinations and responsively causing the second type of IP circuit blocks to operate at a corresponding final maximum frequency value.

16. The machine-readable medium of claim 15 wherein the first type of IP circuit blocks comprises performance cores and wherein the second type of IP circuit blocks comprise efficiency cores, graphics processing cores, interconnect circuitry, memory controllers, or input-output controllers.

17. The machine-readable medium of claim 15 wherein adjusting one or more of the maximum frequency values further comprises multiplying the one or more maximum frequency values by the corresponding stored scalar values to generate the final maximum frequency values.

18. The machine-readable medium of claim 15 wherein causing the first type of IP circuit blocks to operate at one of the plurality of voltage/frequency combinations further comprises transmitting a control message to one or more local power manager circuits associated with the first type of IP circuit blocks, the one or more local power manager circuits to cause the first type of IP circuit blocks to operate at one of the plurality of voltage/frequency combinations.

19. The machine-readable medium of claim 15 wherein the scalar values comprise predetermined values determined using post silicon tuning and stored in a non-volatile memory.

20. The machine-readable medium of claim 15 further comprising:
determining additional maximum frequency values for one or more additional types of IP circuit blocks corresponding to the plurality of voltage/frequency combinations, the additional maximum frequency values based on the stored voltage/frequency curve data;
adjusting one or more of the additional maximum frequency values based on one or more corresponding stored scalar —values to determine final additional maximum frequency values; and
causing the one or more additional types of IP circuit blocks to operate at one of the final additional maximum frequency values corresponding to the one of the plurality of voltage/frequency combinations at which the first type of IP circuit blocks are to operate.

21. The machine-readable medium of claim 15, wherein the power management circuitry is to control an external voltage regulator to supply a voltage to the plurality of different types of IP circuit blocks in accordance with the one of the plurality of voltage/frequency combinations at which the first type of IP circuit blocks are to operate.
